(19) United States
(12) Patent Application Publication
(10) Pub. No.: US 2026/0277676 A1
(43) Pub. Date: Sep. 17, 2026

(54) RESOURCE OPTIMIZATION LEVERAGING ARTIFICIAL INTELLIGENCE (AI) MODELS

(71) Applicant: Chalice Custom Algorithms, Inc., Brooklyn, NY (US)

(72) Inventors: Tylynn Pettrey, Tampa, FL (US); Joseph Wilson, Atlanta, GA (US); Michael Martin, Bristol, RI (US)

(21) Appl. No.: 19/677,939

(22) Filed: May 14, 2026

Related U.S. Application Data
(63) Continuation of application No. 18/963,307, filed on Nov. 27, 2024.

(51) Int. Cl. G06F 9/50

(52) U.S. Cl. CPC G06F 9/5005; G06F 2209/501

(57) ABSTRACT

An allocation platform for resource provisioning can dynamically allocate resources. The allocation platform can obtain input data, historical data, and a total number of resources to allocate. The allocation platform can input the input data and the total resources into a first AI model, which outputs provisions allocating the total resources among numerous artifacts. The allocation platform can input the historical data into a second AI model, which outputs statuses associated with components, where the components are associated with each artifact. The allocation platform can then input the provisions and the statuses into a third AI model, which outputs bids associated with the artifacts. The allocation platform can output these bids to a resource provisioning platform. The allocation platform can modify the bids based on performance of the bids and a best-fit curve for the historical data. The allocation platform can output the modified bids to the resource provisioning platform.

### CROSS-REFERENCE TO RELATED APPLICATIONS

This application is a continuation of U.S. Patent Application No. 18/963,307, filed on November 27, 2024, entitled RESOURCE OPTIMIZATION LEVERAGING ARTIFICIAL INTELLIGENCE (AI) MODELS, which is hereby incorporated by reference in its entirety.

### BACKGROUND

Resource allocation is the assignment of available resources to various uses. Resource allocation can be decided by using computer programs applied to a specific domain.

### BRIEF DESCRIPTION OF THE DRAWINGS

FIG. 1A shows an example computing environment that includes an allocation platform in accordance with some implementations of the present technology.

FIG. 1B shows an example computing environment that includes the allocation platform in accordance with some implementations of the present technology.

FIG. 2 shows an example workflow for the allocation platform in accordance with some implementations of the present technology.

FIG. 3A shows an example graphical user interface (GUI) that demonstrates aspects of bid trends associated with the allocation platform in accordance with some implementations of the present technology.

FIG. 3B shows an example GUI that demonstrates aspects of current bids of the allocation platform in accordance with some implementations of the present technology.

FIG. 3C shows an example GUI that demonstrates aspects of a pacing dashboard of the allocation platform in accordance with some implementations of the present technology.

FIG. 4 is a flowchart depicting an example method of operation of the allocation platform of FIGS. 1A and 1B, in accordance with some implementations of the present technology.

FIG. 5 illustrates a layered architecture of an AI system that can implement the machine learning (ML) models of the allocation platform of FIGS. 1A and 1B, in accordance with some implementations of the present technology.

FIG. 6 is a block diagram showing some of the components typically incorporated in at least some of the computer systems and other devices on which the allocation platform operates in accordance with some implementations of the present technology.

FIG. 7 is a system diagram illustrating an example of a computing environment in which the allocation platform operates in some implementations of the present technology.

The drawings have not necessarily been drawn to scale. For example, some components and/or operations are separated into different blocks or combined into a single block for the purposes of discussion of some of the implementations of the disclosed system. Moreover, while the technology is amenable to various modifications and alternative forms, specific implementations have been shown by way of example in the drawings and are described in detail below. The intention, however, is not to limit the technology to the particular implementations described. On the contrary, the technology is intended to cover all modifications, equivalents and alternatives falling within the scope of the technology as defined by the appended claims.

### DETAILED DESCRIPTION

Network management faces significant challenges relating to resource optimization and allocation. Distributing network bandwidth and routing capacity involves using Quality of Service (QoS) and traffic shaping techniques to prioritize critical traffic and prevent congestion. QoS policies can ensure that high-priority applications, such as video conferencing or VoIP, receive the necessary bandwidth to function smoothly. Traffic shaping can control the flow of data to avoid network congestion and ensure fair distribution of bandwidth among users. However, implementing these techniques requires a comprehensive understanding of network traffic patterns and the ability to adapt to changing conditions in real-time. Policies must be continuously monitored and adjusted to maintain optimal performance, which is a complex and resource-intensive task.

Moreover, the integration of diverse data sources and varying data formats adds another layer of complexity to resource allocation. In a distributed computing environment, data may come from different systems, each with its own format and standards. Integrating this data into a unified system requires robust data processing and normalization capabilities. Additionally, the system must support real-time adjustments based on performance metrics, which demands advanced analytics and automation tools. These challenges necessitate sophisticated technological solutions that can seamlessly integrate and process diverse data sets to create effective and adaptable resource allocation strategies. The ability to dynamically allocate resources based on real-time data is crucial for maintaining system performance and meeting the demands of modern applications.

This patent document discloses techniques that can be implemented to overcome the aforementioned technical challenges. As an illustrative example, the allocation platform is able to integrate diverse data sources, offering computing environments insights that are typically unavailable, thus enabling a more comprehensive optimization strategy. Unlike traditional resource allocation methods, the allocation platform can provide an adaptable solution, as its modular design can cater to different computing needs and environments. Additionally, the allocation platform can forecast optimal resource allocations based on numerous factors. This approach ensures efficient distribution of CPU cycles, memory, bandwidth, and other resources across multiple processes and applications, incorporating forecasting, optimization, and load balancing algorithms to meet performance goals. By dynamically adjusting resource allocations in real-time, the allocation platform improves upon static allocation methods. Moreover, the system frequently adjusts allocations to maintain real-time performance across different computing tasks. The allocation platform thus offers a robust and flexible solution for resource allocation in computing environments.

Resource optimization challenges arise in the context of communication and outreach efforts, as well. Communication and outreach resources must be allocated over time, across regions, and between products and campaigns. The technological drawbacks of current options are significant. Current solutions, such as Demand-Side Platforms (DSPs) and Walled Gardens, are general-use platforms, and the platform algorithms that these platforms provide are limited. Moreover, they rely heavily on online data and platform-specific proxies for optimization. This reliance limits the ability to leverage comprehensive offline data, which is crucial for a holistic communication strategy. Existing Retail Media Networks (RMNs) offer closed ecosystems that often restrict flexibility in data integration and cross-platform optimization. This restriction can make it challenging to fully align communication strategies with diverse performance indicators. Additionally, data is siloed in the current approaches, making it extremely difficult to apply the same business logic and resulting algorithms across multiple platforms. This fragmentation hinders the ability to create a cohesive and effective communication strategy that spans both online and offline channels.

Moreover, developing communication campaigns for different geographic areas presents additional technological challenges. A significant issue arises from the need for localized data to tailor campaigns effectively to regional preferences and behaviors. This requires robust data collection and analysis capabilities that can handle diverse data sources, including local trends and behavior patterns. Additionally, integrating this localized data into a unified allocation platform is often complicated by varying data formats and standards across regions. The technological infrastructure must also support real-time adjustments to campaigns based on regional performance metrics, which demands advanced analytics and automation tools. These challenges necessitate advanced technological solutions that can seamlessly integrate and process diverse data sets to create effective and adaptable region-specific communication campaigns.

The disclosed techniques can be implemented to overcome these technical challenges, as well. As an illustrative example, the allocation platform is able to integrate offline data, which provides organizations with insights not conventionally available and enables a more holistic optimization strategy. The allocation platform further offers an open, flexible alternative to existing RMNs. The allocation platform offers a modular design that allows for the optimization of a wide variety of first-party and third-party data, adapting to different organizational needs and environments. Furthermore, the allocation platform employs AI models to predict the best allocations based on numerous variables. This enables effective allocation across geographic regions, contracts, and formats while integrating forecasting, optimization, and pacing algorithms to achieve organizational objectives. The allocation platform removes reliance on platform data and platform specific algorithms by sitting above individual platforms and thus offers comprehensive cross-platform optimization, unifying strategies and enhancing performance. Finally, the allocation platform can dynamically and frequently adjust allocations using regression splines to ensure real-time pacing across geographic regions. By addressing these challenges through the disclosed methods, the allocation platform provides a comprehensive solution for resource allocation.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Example Implementations of an Allocation Platform

In some implementations, the allocation platform relates to resource allocation across a variety of contexts and technologies. In computer systems, resource allocation involves assigning CPU time, memory, and I/O bandwidth to different processes or applications, managed by the operating system using scheduling algorithms. In cloud computing, resource allocation involves distributing virtualized resources such as virtual machines, storage, and network bandwidth among users or applications, with techniques such as auto-scaling and load balancing. Network management involves distributing network bandwidth and routing capacity using QoS and traffic shaping to prioritize critical traffic and prevent congestion. In project management, resource allocation involves assigning human resources, budget, and time to tasks. Manufacturing and production involve distributing raw materials, labor, and machinery among production lines, using just-in-time inventory management and production scheduling. In communication technology, resource allocation involves distributing budget, media channels, and creative assets across various campaigns and platforms to optimize reach and engagement.

Resource allocation in the communication context can span many channels, media, and technologies. Communications can include outreach, advertising, and public relations, as well as many other forms. Digital advertising can include display advertisements, social media advertisements, search engine marketing (SEM), video advertisements, and native advertising. Email marketing can involve newsletters, promotional emails, and drip campaigns. Content marketing can cover blog posts, articles, and infographics, while social media marketing includes organic and sponsored posts, and influencer collaborations. Public relations efforts such as press releases and media relations, event marketing such as webinars and trade shows, and direct mail campaigns with postcards and brochures are also associated with communications technologies. Additionally, telemarketing, community engagement, search engine optimization (SEO), affiliate marketing, mobile marketing, and traditional advertising (e.g., TV, radio, print, and billboards) can be included.

In some implementations, the allocation platform applies to walled gardens as well as DSPs. Walled gardens and DSPs can differ in their operational models and data ecosystems. Walled gardens can include closed ecosystems in which the platform controls both inventory and data, offering rich first-party data but limiting external data integration and transparency. The approach within walled gardens can focus on maximizing the use of the platform’s unique data and features, such as advanced audience segmentation and engagement metrics, to drive campaign performance.

In contrast, DSPs can be open systems that allow organizations to purchase digital media across various websites through real-time bidding (RTB), offering extensive third-party data integration and flexibility. While walled gardens provide advanced targeting within a controlled environment, DSPs offer broader reach and more granular campaign management. Varied approaches can thus be used for walled gardens and DSPs due to the differences in how these systems operate and the data they provide. However, any of the implementations discussed herein are applicable to various different types of systems, including both walled gardens and DSPs.

As an illustrative example, the allocation platform serves as an alternative or an addition to RMNs, offering comprehensive integration and optimization of first-party data and third-party data across various geographic regions, contracts, and formats. The allocation platform features cohesive integration of availability forecasting, bid optimization, and pacing algorithms to maximize performance while minimizing costs. The allocation platform can adapt to budget changes, seasonality, inventory prices, and media plan adjustments, allowing for effective cross-platform optimization and integration.

The disclosed techniques can thus enhance the efficiency and effectiveness of resource allocation efforts across many contexts by leveraging comprehensive data analytics to optimize performance. By integrating data from various sources and applying advanced algorithms, the allocation platform provides a unified approach to managing and optimizing resource allocation across diverse environments, ensuring that allocations are both targeted and adaptable.

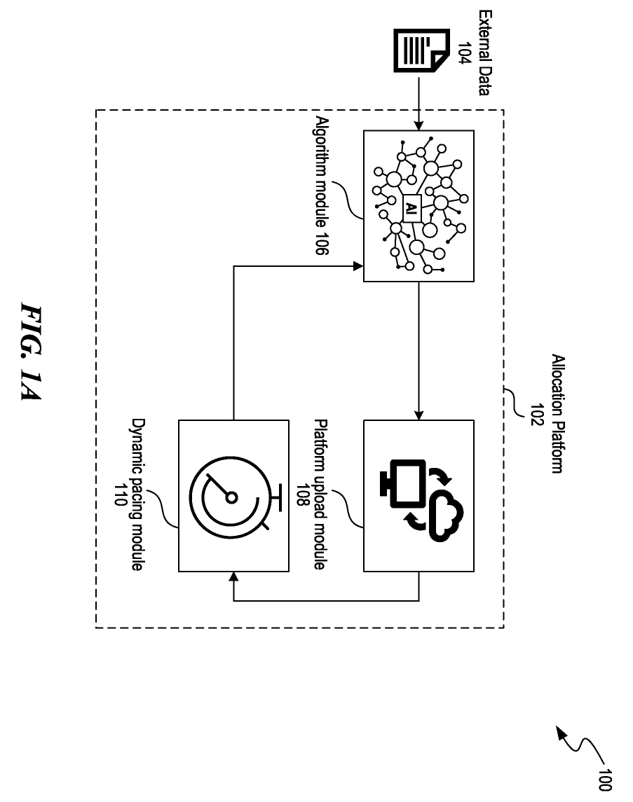

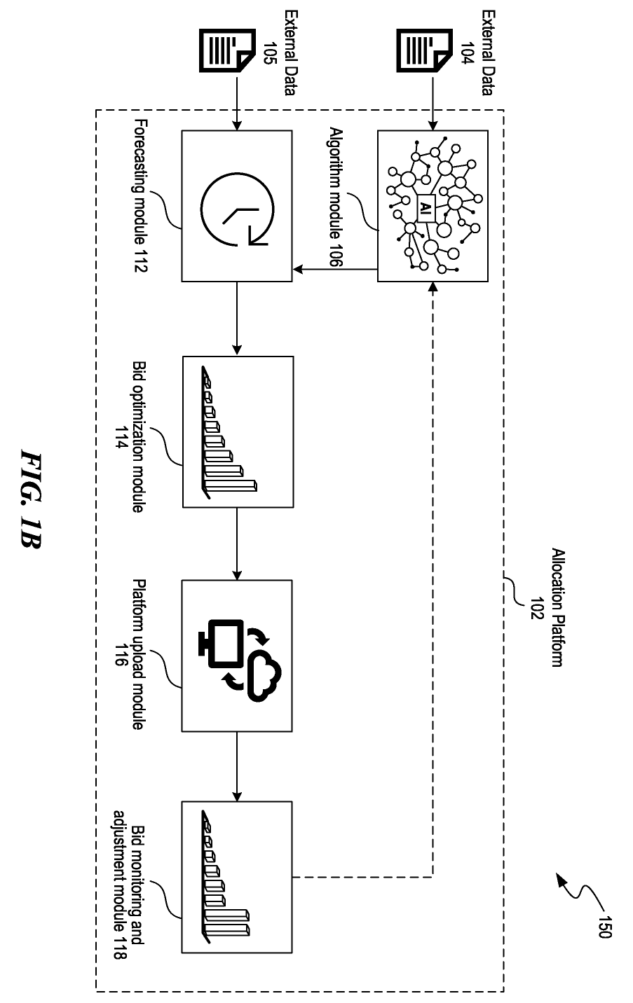

FIG. 1A shows an example computing environment 100 that includes an allocation platform 102 in accordance with some implementations of the present technology. In some implementations, computing environment 100 relates to a walled garden platform. In some implementations, computing environment 100 relates to another type of platform. As shown in FIG. 1A, allocation platform 102 can receive external data 104. An algorithm module 106 can receive the external data 104. The algorithm module 106 can employ ML models to predict the best allocation of budgets based on numerous variables (e.g., sales volume, velocity, market conditions, and inventory availability). The algorithm module 106 can output allocations, which are formatted for a platform upload module 108. For example, the platform upload module 108 uploads allocations to a user interface of the allocation platform 102, on which the user can view and modify allocations. A dynamic pacing module 110 can make additional modifications to pace the allocations. These modifications can be fed back into the algorithm module 106. This process can be cyclical in nature, as the allocation platform 102 continuously receives new external data 104, which is fed into the algorithm module 106 to adjust and optimize budget allocations in real-time.

In some implementations, the allocation platform 102 employs an agentic approach. In an agentic approach, algorithm module 106, platform upload module 108, and dynamic pacing module 110 can each function as autonomous agents, actively managing respective tasks and collaborating to achieve a common goal. Algorithm module 106 (e.g., a first agent) can be responsible for taking inputs and generating predicted provisions. Platform upload module 108 (e.g., a second agent) can upload the predicted provisions to a platform for review and modification. Dynamic pacing module 110 (e.g., a third agent) can handle pacing over time in light of budgets and timelines, using outputs from the second agent to make real-time adjustments and optimizations. By employing an agentic approach, each agent can operate independently yet cohesively, dynamically adapting to new data and evolving conditions.

In some implementations, the allocation platform (e.g., the allocation platform 102, as shown in FIG. 1A) obtains, from an external source, a set of input data. In some implementations, the input data corresponds to the external data 104, as shown in FIG. 1A. The set of input data can relate to various features or artifacts. In some implementations, a feature or an artifact is a value that are to receive an allocation of budget (e.g., a geographic region, a computing service, etc.). The external data can be first party or third party data. Such data can include offline data, such as offline sales data (e.g., direct sales data), offline sell-through data, or offline inventory data. In some implementations, the data is owned or licensed by the external source. The allocation platform can employ automated data ingestion, ensuring that diverse data sources are seamlessly integrated into the platform without manual intervention.

The external data (e.g., performance metrics defined by the advertiser or user interaction logs collected from a web application), can first be normalized to ensure comparability across different units. For example, data is adjusted to a common scale or format, eliminating any discrepancies caused by varying units of measurement or differing data ranges. This process can involve transforming the data so that it can be compared and analyzed consistently, regardless of its original format. For example, sales figures from different regions are normalized to account for differences in currency or population size, allowing for a fair comparison. Each input can be weighted according to predefined criteria reflecting its relevance to the allocation process.

In some implementations, the allocation platform determines one or more parameters based on regulations for sets of data. The allocation platform can then filter the set of input data according to the one or more parameters. To ensure compliance with data privacy regulations, such as GDPR, the allocation platform can determine parameters that govern the use and processing of these data sets. These parameters can include user consent status, data anonymization requirements, and geographic restrictions. The platform then filters the input data, accordingly, ensuring that only compliant data is used for resource allocation and optimization.

In some implementations, the data is structured or unstructured. Structured data can be organized and searchable and can be stored in databases with defined fields such as sales figures, customer demographics, and inventory levels. This type of data can be straightforward to analyze and integrate into algorithms. On the other hand, unstructured data lacks a predefined format and can include information such as social media posts, customer reviews, and multimedia content. Despite its complexity, unstructured data can provide valuable insights when processed and analyzed using advanced techniques like Natural Language Processing (NLP) and ML. In some implementations, unstructured data is converted into structured data before it is used.

In some implementations, the allocation platform standardizes online and offline data to be processed by the allocation platform. Standardizing online and offline data can involve integrating diverse data sources such as off-platform data, including retail sales data, foot traffic data, search data, trends data, and social media data. This process can encompass Natural Language Processing (NLP) analysis and sentiment analysis of certain data types. The standardized data can be structured in a specific format, such as a CSV file containing certain fields, including value. These fields can include browser type, supply vendor, domain, and ID. By standardizing this data, organizations can create a unified and comprehensive dataset that facilitates more accurate and insightful analysis. This can enable better decision-making, more effective targeting, and improved campaign performance by leveraging both online and offline data sources in a cohesive manner.

In some implementations, the allocation platform receives a total number of resources to provision among the features. The allocation platform can be tasked with distributing the total number of resources across these features in a way that optimizes performance and meets predefined objectives. As an illustrative example, the total number of resources can be a budget for an advertising campaign, and the allocation platform can be tasked with allocating the resources between multiple geographic region or zip codes. In some implementations, the allocation platform receives the total number along with the external data. In some implementations, the allocation platform determines the total number of resources based on historical data or other information.

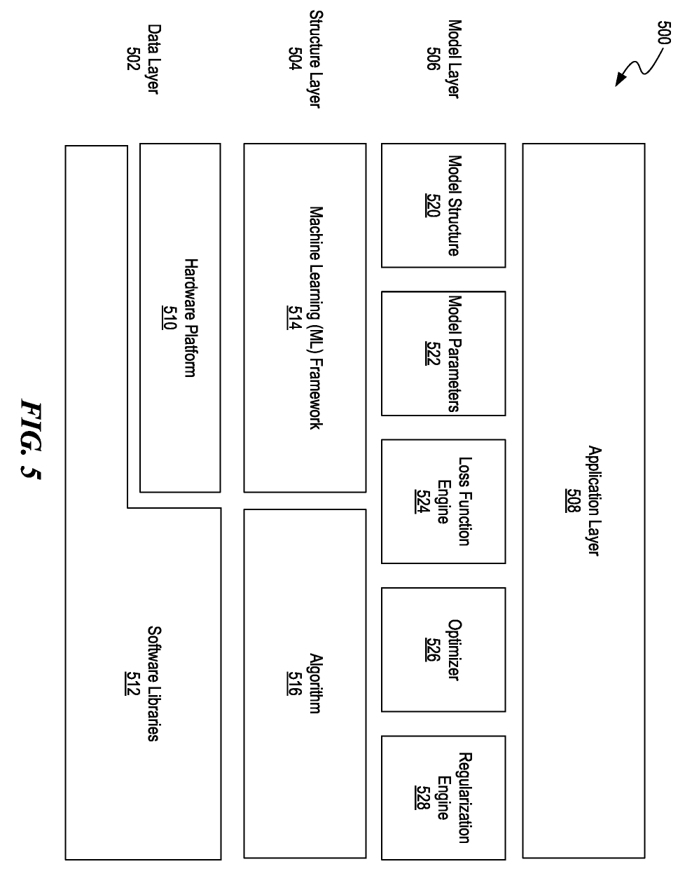

The allocation platform can input, into a trained AI model, the set of input data and the total number of resources. In some implementations, this causes the trained AI model to output provisions of the total number of resources among the features. For example, the trained AI model is configured to output resource provisioning among features. In some implementations, the trained AI model corresponds to algorithm module 106, as shown in FIG. 1A. The training process can involve feeding the model large datasets that represent different scenarios and outcomes, allowing it to learn patterns and relationships between the input data and the desired allocation outcomes. Techniques such as supervised learning, in which the model is trained on labeled data with known outcomes, and reinforcement learning, where the model learns by receiving feedback on its actions, can be employed to enhance the model’s accuracy and effectiveness. Types of ML models and methods of training are discussed in greater detail in relation to FIG. 5.

As an illustrative example, the trained AI model can be trained using historical data that includes past budget allocations, performance metrics, and various contextual factors such as market conditions and customer behavior. The AI model can be trained using data from previous advertising campaigns, including information on how budgets were allocated across different geographic regions, zip codes, or demographic segments, and the resulting performance in terms of key performance indicators (KPIs) like sell-through rate (STR), conversion rates, and return on investment (ROI). By analyzing this data, the model learns which allocation strategies tend to yield the best results under various conditions. Once trained, the AI model can take new input data, such as current market trends and available inventory, and output an optimized budget allocation that maximizes the effectiveness of the ad campaign while ensuring efficient use of resources.

In some implementations, inputting, into the trained AI model, the set of input data and the total number of resources causes the trained AI model to output provisions of the total number of resources among the features. For example, the trained AI model analyzes the input data, which can include various metrics such as sales volume, market conditions, and inventory levels, to determine the optimal allocation of resources. The model can identify patterns and relationships within the data, enabling the model to make informed decisions on how to distribute resources effectively. The trained AI model can output provisions to each feature accordingly.

The allocation platform can output the provisions to a resource provisioning platform. For example, the allocation platform uploads the provisions (e.g., as generated by the trained AI model) to a platform. In some implementations, the resource provisioning platform corresponds to platform upload module 108, as shown in FIG. 1A. The allocation platform can interact with platform upload procedures through various interfaces, including Representational State Transfer Application Programming Interfaces (REST APIs), GraphQL APIs, and Robotic Process Automation (RPA). These interactions can facilitate the efficient transfer and updating of data across different platforms, ensuring that the allocation platform remains synchronized and up-to-date.

In some implementations, the platform is operated by the allocation platform. For example, the platform includes a GUI that enables users to view, modify, delete, and add provisions. This user interface can provide a comprehensive overview of the resource allocations, allowing users to make informed decisions and adjustments as needed. The GUI can display detailed analytics and visualizations, such as charts and graphs, to illustrate the distribution and performance of resources. Furthermore, the platform can support integration with other systems, facilitating seamless data exchange and enhancing operational efficiency. For example, the allocation platform integrates into external platforms, providing them with information through Application Programming Interfaces (APIs), Spline Font Database (SFD), and other data exchange formats. This integration allows for iterative feedback looping, as data from the external platforms can be fed back into the allocation platform to refine and optimize future resource provisions. This continuous feedback loop ensures that the allocation platform remains responsive to changing conditions and can dynamically adjust resource allocations in real-time.

In some implementations, outputting the provisions to a platform causes execution of the provisions. The allocation platform can output the provisions to the platform in parallel with causing execution of the provisions. The allocation platform can integrate, into a resource provisioning platform, external systems responsible for executing the provisions. In some embodiments, outputting the provisions to the platform may prompt one or more external systems to execute the provisions. The allocation platform or an external system can carry out or implement actions that are associated with executing the provisions. In some implementations, this involves actively submitting bids through an advertising platform or auction system. In some implementations, this involves actively distributing available bandwidth according to the provisions using network management tools and protocols.

In some implementations, the allocation platform receives a log indicating resources provisioned among the features. This log can serve as a detailed record of how resources have been distributed across various features, capturing essential data such as the amount of resources allocated, the specific features receiving the resources, and the time of allocation. By maintaining this log, the platform can track the effectiveness of resource distribution, identify patterns, and detect any discrepancies or inefficiencies. The log data can be used for auditing purposes, ensuring transparency and accountability in resource management. Additionally, the log provides valuable insights that can be fed back into the allocation platform’s algorithms, enabling continuous improvement and optimization of future resource provisions. This iterative process helps the platform adapt to changing conditions and refine its strategies, ultimately enhancing overall performance and achieving better alignment with organizational goals.

In some implementations, the allocation platform inputs the log into the trained AI model to cause the trained AI model to output updated provisions of the total number of resources among the features. By incorporating the log data, the trained AI model can analyze historical allocation patterns and performance metrics, allowing the trained AI model to identify areas for improvement and adjust future resource distributions accordingly. This process ensures that the model continuously learns from past allocations, enhancing its predictive accuracy and decision-making capabilities. The updated provisions generated by the AI model can then be implemented to optimize resource utilization, ensuring that each feature receives the appropriate amount of resources based on current needs and priorities. The continuous feedback loop created by inputting the log data into the AI model can foster an environment of ongoing adaptation, leading to more effective and sustainable resource management.

In some implementations, the trained AI model (e.g., algorithm module 106) applies multi-armed bandit (MAB) logic to dynamically allocate budgets, balancing between maximizing high-performing features and avoiding saturation. The MAB algorithm faces a trade-off between investing in low-performing options (e.g., features) to improve performance and exploiting known high-performing options to maximize returns. Initially, the allocation platform can allocate budgets evenly or based on prior knowledge to gather performance data across all features, helping to understand the baseline performance of each feature. In some implementations, the allocation platform continuously tracks the performance of each feature, measuring KPIs such as conversion rates, STR, or sales volume. This data is used to update the probability estimates of each feature’s potential to deliver high returns. Based on the performance data, the MAB algorithm can dynamically adjust the budget allocation. Features with higher estimated probabilities of success receive a larger share of the budget, while those with lower probabilities receive less, ensuring that high-performing features are maximized while still allowing for some investment in other features.

To avoid market or inventory saturation, the allocation platform monitors the performance trends and adjusts allocations to prevent over-investing in any single feature. If a high-performing feature begins to show signs of diminishing returns, the algorithm can reduce its budget allocation and reallocate it to other promising features. In some implementations, the MAB algorithm operates in a continuous loop, constantly updating its estimates and reallocating budgets based on the latest performance data. This cyclical process ensures that the allocation platform remains adaptive to changing market conditions and inventory availability, optimizing budget allocation over time.

In some implementations, the allocation platform outputs the updated provisions to the resource provisioning platform. For example, the updated provisions generated by the trained AI model are transmitted to a platform, where they can be automatically implemented or reviewed by users. The updated provisions can be uploaded to the resource provisioning platform using the methods and techniques discussed above in relation to the upload of the original provisions. In some implementations, the updated provisions replace the original provisions. In some implementations, the updated provisions are generated as an alert, notifying users of the update.

In some implementations, outputting the updated provisions to the platform causes execution of the updated provisions. The allocation platform can output the updated provisions to the platform in parallel with causing execution of the updated provisions. The allocation platform can integrate, into a resource provisioning platform, external systems responsible for executing the updated provisions. In some embodiments, outputting the updated provisions to the platform may prompt one or more external systems to execute the updated provisions. The allocation platform or an external system can carry out or implement actions that are associated with executing the updated provisions. In some implementations, this involves actively submitting updated bids through an advertising platform or auction system. In some implementations, this involves actively distributing updated available bandwidth according to the updated provisions using network management tools and protocols.

As previously mentioned, the allocation platform can perform some or all of the aforementioned processes in a cyclical manner. For example, certain processes are performed once at initialization of a campaign, while other processes can be performed more frequently. In some implementations, certain processes repeat at a particular frequency (e.g., every 15 minutes). Other time-based triggers can be set, such as daily or hourly updates. In some implementations, the process repeats in response to a different trigger. These triggers can include budget changes, as adjustments in the available budget necessitate a reallocation of resources. Additionally, the process can be triggered by new availabilities, such as when a new audience segment is added. Swapping out an advertisement can also serve as a trigger, prompting the allocation platform to re-evaluate and adjust resource allocations to maintain campaign effectiveness. Events of public interest, such as the Super Bowl for sports betting or political events during election seasons, can significantly impact resource needs and availability, necessitating immediate adjustments. By incorporating these triggers, the allocation platform ensures that resource distribution remains dynamic and responsive to real-time changes.

In some implementations, the allocation platform determines a pace at which the total number of resources are to be provisioned among the features. For example, a pace refers to the controlled rate at which budgets or resources are spent over a specified period. Effective pacing ensures that the allocated funds are distributed evenly and strategically throughout the campaign duration, preventing overspending or underspending. This involves real-time monitoring and dynamic adjustments to bids and spending rates based on current performance metrics and market conditions. Once the allocation platform determines the pace, the allocation platform can determine, based on the log, whether an actual pace at which the total number of resources are being provisioned matches the pace at which the total number of resources are to be provisioned. For example, the allocation platform determines whether resources are being spent at an appropriate pace based on the budget. The allocation platform can determine, based on the log, that an actual pace at which the total number of resources are being provisioned does not match the pace at which the total number of resources are to be provisioned. For example, the allocation platform determines that resources are being spent too quickly or are not being utilized enough. In some implementations, inputting the log into the trained AI model is performed in response to determining that the actual pace at which the total number of resources are being provisioned does not match the pace at which the total number of resources are to be provisioned. For example, the determination that resources are being spent too quickly or are not being utilized enough triggers the allocation platform to update the provisions by inputting the log into the trained AI model to cause the model to generate updated provisions. In some implementations, these techniques correspond to the dynamic pacing module 110, as shown in FIG. 1A.

In some implementations, the allocation platform determines a performance metric for the provisions. The performance metric can indicate a current performance of the provisions or a historic future performance of the provisions. For example, the performance metric measures the STR of an advertising campaign or the ROI for a specific geographic region. In some implementations, the allocation platform determines that the performance metric does not satisfy a performance threshold. For instance, if the STR falls below a predefined threshold, it can indicate that the current advertisement placements are not engaging the target audience effectively. In some implementations, inputting the log into the trained AI model is performed in response to determining that the performance metric does not satisfy the performance threshold. For example, the determination that the performance metric does not satisfy the performance threshold triggers the allocation platform to update the provisions by inputting the log into the trained AI model to cause the model to generate updated provisions. This can involve reallocating the budget to different ad formats or adjusting bids in real-time to improve performance.

In some implementations, responsive to detecting an excess provisioning trigger, the allocation platform causes the provisions to terminate. The excess provisioning trigger can be an indication of excess resource provisioning within a predetermined time period. For example, the allocation platform employs a pacing algorithm that adjusts bids to ensure precise budget pacing. If the allocation platform detects that resources are being spent too quickly, surpassing the allocated budget within the specified time frame, it can activate a “killswitch” mechanism. For example, this mechanism halts further bids and resource allocation to prevent overspending.

FIG. 1B shows an example computing environment 150 that includes the allocation platform 102 in accordance with some implementations of the present technology. In some implementations, computing environment 150 relates to a DSP. In some implementations, computing environment 150 relates to another type of platform. As shown in FIG. 1B, allocation platform 102 can receive external data 104. For example, the algorithm module 106 receives the external data 104. In some implementations, the algorithm module 106 is the same as or different from the algorithm module 106 shown in FIG. 1A. The algorithm module 106 can employ ML models to predict the best allocation of budgets based on numerous variables (e.g., sales volume, velocity, market conditions, and inventory availability). The algorithm module 106 can output allocations to forecasting module 112. In some implementations, forecasting module 112 also receives additional external data 105. For example, external data 105 includes historical data. Forecasting module 112 can use the external data 105 as well as the outputs from the algorithm module 106 to generate forecasting (e.g., of inventory availability). This availability can be used for bid optimization module 114, which can generate bids based on the forecasted inventory. In some implementations, platform upload module 116 uploads bids to a user interface of the allocation platform 102, on which the user can view and modify the bids. Bid monitoring and adjustment module 118 can make modifications to the bids, for example, based on updates, pacing, or other criteria. These modifications can be fed back into the algorithm module 106. This process can be cyclical in nature, as the allocation platform 102 continuously receives new external data 104, which is fed into the algorithm module 106 to adjust and optimize budget allocations in real-time.

In some implementations, the allocation platform 102 employs an agentic approach. In an agentic approach, algorithm module 106, forecasting module 112, bid optimization module 114, platform upload module 116, and bid monitoring and adjustment module 118 can each function as autonomous agents, actively managing respective tasks and collaborating to achieve a common goal. Algorithm module 106 (e.g., a first agent) can be responsible for taking inputs and generating predicted provisions. Forecasting module 112 (e.g., a second agent) can be responsible for forecasting inventory availabilities for different geographic areas. Bid optimization module 114 (e.g., a third agent) can be responsible for generating bids based in the predicted provisions and forecasted availabilities. Platform upload module 116 (e.g., a fourth agent) can upload the predicted provisions to a platform for review and modification. Bid monitoring and adjustment module 118 (e.g., a fifth agent) can adjust bids in light of budgets and timelines. By employing an agentic approach, each agent can operate independently yet cohesively, dynamically adapting to new data and evolving conditions.

In some implementations, the allocation platform (e.g., the allocation platform 102, as shown in FIG. 1B) obtains, from an external source, a set of input data and a set of historical data. In some implementations, the set of input data and the set of historical data corresponds to external data 104 and external data 105, respectively, as shown in FIG. 1B. The set of input data and the set of historical data can relate to various features. As previously discussed, a feature can be a value that receives an allocation of budget (e.g., a geographic region, a zip code, etc.). The data can be first party or third party data. Such data can include offline sales data (e.g., direct sales data) or inventory data. In some implementations, the historical data includes historical win log reports. In some implementations, the data is owned or licensed by the external source. In some implementations, the external data is normalized or weighted before processing. In some implementations, the data is filtered for compliance with one or more regulations, as previously discussed. The external data can be structured or unstructured data, and unstructured data can be converted to structured data before processing.

In some implementations, each feature of the features is associated with a corresponding set of components. In some implementations, a set of components includes items associated with a given feature. Components can be products being advertised within a given geographic area. As an illustrative example, an organization can run a targeted advertising campaign within the United States. In this scenario, the features can include various geographic areas such as New York City, Los Angeles, and Chicago. Each of these geographic areas can be associated with a corresponding set of components, such as the specific products available for sale in those locations. These products can be advertised specifically within their respective geographic areas, ensuring that the advertisements reach potential customers who are most likely to visit the stores and purchase these products.

In some implementations, the allocation platform receives a total number of resources to provision among the features. The allocation platform can be tasked with distributing the total number of resources across these features in a way that optimizes performance and meets predefined objectives. As an illustrative example, the total number of resources can be a budget for an advertising campaign, and the allocation platform can be tasked with allocating the resources between multiple geographic region or zip codes. As an illustrative example, the total number of computing resources can be a number of available CPU cycles, and the allocation platform can be tasked with allocating the computing resources among multiple computing processes. In some implementations, the allocation platform receives the total number along with the external data. In some implementations, the allocation platform determines the total number of resources based on historical data or other information.

The allocation platform can input, into a first trained AI model, the set of input data and the total number of resources to cause the first trained AI model to output provisions of the total number of resources among the features. In some implementations, this causes the first trained AI model to output provisions of the total number of resources among the features. In some implementations, the first trained AI model corresponds to algorithm module 106, as shown in FIG. 1B. In some implementations, the first trained AI model is configured to output resource provisioning among features. The training process can involve feeding the model large datasets that represent different scenarios and outcomes, allowing it to learn patterns and relationships between the input data and the desired allocation outcomes. Techniques such as supervised learning, in which the model is trained on labeled data with known outcomes, and reinforcement learning, where the model learns by receiving feedback on its actions, can be employed to enhance the model’s accuracy and effectiveness. Types of ML models and methods of training are discussed in greater detail in relation to FIG. 5.

In some implementations, the allocation platform inputs, into a second trained AI model, the set of historical data to cause the second trained AI model to output component statuses for each corresponding set of components associated with each feature. In some implementations, the second trained AI model corresponds to forecasting module 112, as shown in FIG. 1B. In some implementations, component statuses correspond to inventory availability. For example, each component is a product offered at a particular location, and a component status can indicate whether that product is available at that particular location. Examples of component statues can include available, not available, backordered, discontinued, or other statuses.

In some implementations, the second trained AI model is trained to predict statuses of components based on historical data. In some implementations, the second trained AI model is configured using techniques previously disclosed or as discussed below in greater detail in relation to FIG. 5. In some implementations, the second trained AI model predicts expected openRTB inventory availability for each feature, ensuring optimal pacing and budget utilization. The second trained AI model can use time series forecasting, incorporating statistical techniques such as AutoRegressive Integrated Moving Average (ARIMA) and other models to handle both linear and non-linear trends. While ARIMA is particularly effective for linear trends, the allocation platform can integrate other forecasting models for non-linear patterns in the data. Exponential Smoothing State Space Models (ETS) are useful for handling non-linear trends and seasonality in inventory data. By employing ETS alongside ARIMA, the allocation platform adapts to both linear and non-linear trends, ensuring robust forecasting across different market conditions.

ARIMA combines autoregression (AR), moving average (MA), and differencing to handle data. AR can enable predictions of future values based on prior values of the series and MA can enable predictions of future values based on past forecast errors. To ensure the time series is suitable for ARIMA modeling, the allocation platform can use the Augmented Dickey-Fuller (ADF) test to check for stationarity. If the ADF test statistic is significantly negative (with p < 0.05), the series is considered stationary. The number of lags in the ADF test is determined using the Bayesian Information Criterion (BIC).

Autocorrelation (ACF) and Partial Autocorrelation (PACF) plots can be used to diagnose the data structure and determine appropriate model parameters. ACF measures the correlation between observations and their lagged values, while PACF isolates the relationship between a data point and specific lags. These plots help determine the optimal AR and MA orders for the model. These plots help in understanding the relationships within the data and refining the model to improve its predictive accuracy. By analyzing these plots, the algorithm can better capture the underlying patterns in the data. After fitting the models, residual analysis is performed to check forecast accuracy, and BIC is used to ensure that the most parsimonious model is selected. This step ensures that the second trained AI model remains accurate and reliable over time, continuously improving its performance based on new data.

In some implementations, the allocation platform uses time series transformer models to enhance inventory availability predictions. The transformer architecture, known for its efficiency in handling sequential data, can offer enhanced scalability and accuracy in real-time inventory forecasting, leading to more precise bidding logic and resource allocation.

The second trained AI model applies the above detailed techniques to predict, or forecast, expected inventory availability per feature, enabling precise budget pacing and bid optimization. The second trained AI model can generate hourly forecasts of inventory availability for the campaign duration. These predictions can be iteratively updated, allowing the allocation platform to adapt to new data and market trends and ensuring optimal performance in real-time. For example, if the time series is found to have a significant autoregressive structure, the ARIMA model adjusts budget allocations and pacing based on forecasted availabilities, ensuring efficient resource allocation to achieve certain KPI targets. The second trained AI model can then output the component statuses (e.g., forecasts) for each corresponding set of components (e.g., products) associated with each feature (e.g., geographic location).

In some implementations, the allocation platform inputs, into a third trained AI model, the provisions and the component statuses. This can cause the third trained AI model to output bids associated with the features and corresponding sets of components. In some implementations, the third trained AI model corresponds to bid optimization module 114, as shown in FIG. 1B. For example, the third trained AI model is configured to output bids based on provisioning and component statuses. In some implementations, the third trained AI model determines non-convex optimization. Non-convex optimization problems are characterized by objective functions that can have multiple local minima and maxima, making the search for the global minimum more challenging. The objective of the third trained AI model can be to minimize the cost per thousand impressions (CPM) while ensuring full delivery of the allocated budget in each selected feature. The third trained AI model can attempt to minimize a function subject to constraints on budget and inventory availability.

In some implementations, the third trained AI model employs gradient descent. Gradient descent is an iterative optimization technique used to minimize a given function. Gradient descent can take steps proportional to the negative gradient (e.g., the direction of steepest descent) of the objective function at a current point. Since this is a constrained optimization problem, each iteration of gradient descent can be projected onto the feasible region defined by the constraints (e.g., budget and availability). Projected gradient descent can then come into play. In projected gradient descent, the update step can be modified to ensure that the solution remains within the feasible region. After each gradient update, the result is projected onto the feasible set. This allows the third trained AI model to find the optimal bid price while ensuring that bids remain within the bounds of available inventory and the budget constraint.

In some implementations, once the optimal win-rates are estimated using projected gradient descent, the allocation platform applies a bisection method to further refine the bid prices. The bisection method can iteratively narrow the range of possible bid prices, honing in on the minimum price that guarantees full delivery of the budget. In some implementations, the bisection method involves initializing with a lower bound and upper bound for a bid price. The allocation platform can compute a midpoint. The allocation platform can evaluate the objective function at the midpoint. If the win rate or budget is not satisfied, adjust either the lower or upper bound accordingly, narrowing the range. The allocation platform can repeat this process until the range between the upper and lower bounds is sufficiently small, yielding the optimal bid price at the midpoint. This method allows the allocation platform to provide the recommended bid price in terms of CPM for each hour and feature, ensuring that the budget is fully spent while minimizing CPMs, thus optimizing the total number of times an advertisement is displayed to users given the budget available.

Finally, the allocation platform ensures precise budget pacing by applying regression splines to adjust bidding instructions every 15 minutes, allowing for fine-tuned control in response to market fluctuations and inventory availability. This approach minimizes over- or under-spending by dynamically adjusting bids to maintain the target budget pace across features, such as multiple Designated Market Areas (DMAs). DMAs will be used for purposes of illustration. Intra-day trends, such as sudden changes in inventory availability or fluctuating win rates, can cause over or under-pacing of the budget. Without continuous adjustments, these fluctuations can lead to inefficiencies, where some DMAs can overspend or underspend their allocated budgets. To address this, the allocation platform can continuously monitor spend and applies multipliers to adjust bids in real-time.

In some implementations, the allocation platform uploads the bids to a resource provisioning platform. As previously discussed, the resource provisioning platform corresponds to platform upload module 116, as shown in FIG. 1B. In some implementations, the platform is operated by the allocation platform. For example, the platform includes a GUI that enables users to view, modify, delete, and add provisions. This user interface can provide a comprehensive overview of the resource allocations, allowing users to make informed decisions and adjustments as needed. The GUI can display detailed analytics and visualizations, such as charts and graphs, to illustrate the distribution and performance of resources. Furthermore, the platform can support integration with other systems, facilitating seamless data exchange and enhancing operational efficiency. For example, the allocation platform integrates into external platforms, providing them with information through APIs, SFD, and other data exchange formats. This integration allows for iterative feedback looping, as data from the external platforms can be fed back into the allocation platform to refine and optimize future resource provisions. This continuous feedback loop ensures that the allocation platform remains responsive to changing conditions and can dynamically adjust resource allocations in real-time.

In some implementations, the allocation platform monitors and adjust bids. For example, this process corresponds to bid monitoring and adjustment module 118, as shown in FIG. 1B. For example, the allocation platform determines a performance metric for the bids. For example, the performance metric indicates a current performance of the bids. In some implementations, the performance metric indicates a projected future performance of the bids. The allocation platform can determine a best-fit curve for the set of historical data. For example, the allocation platform uses spline interpolation to calculate a smooth, best-fit curve through the set of historical data, as discussed in greater detail below. The allocation platform can then apply a modification to the bids to generate modified bids. For example, the modification is based on a comparison between the performance metric and the best-fit curve. In some implementations, the modification is further based on a pace at which the total number of resources are to be provisioned among the features. For example, the modification is a multiplier, as discussed below in greater detail.

To achieve precise control over bid pacing, the allocation platform can use spline interpolation to calculate a smooth, best-fit curve through historical bidding data. This allows it to adjust bids based on the current pacing performance and the projected future performance. The spline interpolation method provides a flexible way to model non-linear relationships between the bid multipliers and time, making it ideal for handling intra-day fluctuations. The spline interpolation method divides the day into smaller segments (e.g., 15-minute intervals) and fits a spline to the data points within each segment. This allows for localized adjustments that respond to market conditions over short periods of time. For each 15-minute interval, the allocation platform computes the multiplier that adjusts the current bid. For example, the multiplier is derived from the regression spline and varies with time, ensuring that the bid adjustments reflect the current pacing needs.

The spline interpolation can provide the minimum multiplication factor adjustment necessary each hour (and every 15 minutes) to increase or decrease the win rate, ensuring that the budget is paced correctly. This can be especially critical in markets where inventory availability fluctuates significantly throughout the day. For example, if the allocation platform detects that a DMA is under-pacing (underspending), the multiplier for the next bid cycle will increase the bid to capture more inventory and bring spending back on track. Conversely, if the allocation platform detects that a DMA is over-pacing (overspending), the multiplier will reduce the bid to slow down the pace.

In addition to adjusting bids using spline-based multipliers, the allocation platform incorporates a “killswitch” mechanism. For example, responsive to detecting an excess provisioning trigger, the allocation platform causes the provisions to terminate. The excess provisioning trigger can be an indication of excess resource provisioning within a predetermined time period. For example, the allocation platform employs a pacing algorithm that adjusts bids to ensure precise budget pacing. If the allocation platform detects that resources are being spent too quickly, surpassing the allocated budget within the specified time frame, it can activate the “killswitch” mechanism. For example, this mechanism halts further bids and resource allocation to prevent overspending. This safeguard can add a layer of protection against potential overspend by blocking additional spend to a DMA if the projected budget for the next 15 minutes indicates an overspend. This mechanism is particularly valuable in cases of delayed model runs, lagging DSP feedback, or rapid market shifts that can cause unexpected changes in pacing. The “killswitch” monitors real-time pacing data and uses the projected budget trajectory to determine if any DMA is at risk of overspending. If the projected spend exceeds the allocated budget, the allocation platform halts all bids to that DMA until the situation stabilizes, ensuring precise regional budget delivery.

The allocation platform can implement these methods to continuously adjust and control bid pacing across multiple DMAs, ensuring that budgets are precisely managed in real time. By leveraging regression splines, the allocation platform creates a smooth and adaptive bidding strategy that responds to intra-day market conditions. The spline interpolation can provide a more flexible and accurate method than simple linear adjustments, as it captures non-linear trends in the data. The allocation platform’s 15-minute interval adjustments, combined with the “killswitch” mechanism, ensure that budgets are neither overspent nor underspent, delivering exact pacing across hundreds or even thousands of 7 regions. By dynamically adjusting bids based on real-time performance data, the allocation platform maintains optimal performance across all DMAs while adhering to the allocated budget.

In some implementations, the allocation platform outputs the modified provisions (e.g., bids) to the resource provisioning platform. As discussed above, the resource provisioning platform can correspond to platform upload module 116, as shown in FIG. 1B. The modified provisions can be uploaded to the resource provisioning platform using the methods and techniques discussed above. In some implementations, the modified provisions replace earlier provisions. In some implementations, the modified provisions are generated as an alert, notifying users of the modification.

In some implementations, outputting the modified provisions to the platform causes execution of the modified provisions. The allocation platform can output the modified provisions to the platform in parallel with causing execution of the modified provisions. The allocation platform can integrate, into a resource provisioning platform, external systems responsible for executing the modified provisions. In some embodiments, outputting the modified provisions to the platform may prompt one or more external systems to execute the modified provisions. The allocation platform or an external system can carry out or implement actions that are associated with executing the modified provisions. In some implementations, this involves actively submitting modified bids through an advertising platform or auction system. In some implementations, this involves actively distributing modified available bandwidth according to the modified provisions using network management tools and protocols.

As previously mentioned, the allocation platform can perform some or all of the aforementioned processes in a cyclical manner. For example, certain processes are performed once at initialization of a campaign, while other processes can be performed more frequently. In some implementations, certain processes repeat at a particular frequency (e.g., every 15 minutes). Other time-based triggers can be set, such as daily or hourly updates. In some implementations, the process repeats in response to a different trigger. These triggers can include budget changes, as adjustments in the available budget necessitate a reallocation of resources. Additionally, the process can be triggered by new availabilities, such as when a new audience segment is added. Swapping out an advertisement can also serve as a trigger, prompting the allocation platform to re-evaluate and adjust resource allocations to maintain campaign effectiveness. Events of public interest, such as the Super Bowl for sports betting or political events during election seasons, can significantly impact resource needs and availability, necessitating immediate adjustments. By incorporating these triggers, the allocation platform ensures that resource distribution remains dynamic and responsive to real-time changes. The allocation platform can initiate generation of updated bids in response to these or other triggers.

The allocation platform can detect a feedback trigger, such as a change in the total number of resources, a passage of a predetermined amount of time, or an occurrence of a predetermined event. In response to detecting the feedback trigger, the allocation platform can initiate an update. For example, the allocation platform inputs, into the first trained AI model, the modified bids to cause the first trained AI model to output updated provisions of the total number of resources among the features. The allocation platform can input, into the second trained AI model, an updated set of historical data to cause the second trained AI model to output updated component statuses for each corresponding set of components associated with each feature. The allocation platform can then input, into the third trained AI model, the updated provisions and the updated component statuses to cause the third trained AI model to output updated bids. Finally, the allocation platform can output the updated bids to the resource provisioning platform.

In some implementations, updated historical data triggers the allocation platform to update the bids. For example, the allocation platform obtains an updated set of historical data. The allocation platform can input, into the second trained AI model, the updated set of historical data. This can cause the second trained AI model to output updated component statuses for each corresponding set of components associated with each feature. For example, the updated component statuses indicate availabilities of products associated with each geographic area. The allocation platform can then input, into the third trained AI model, the provisions (e.g., as originally generated) and the updated component statuses. This can cause the third trained AI model to output updated bids. The allocation platform can then output the updated bids to the resource provisioning platform, using methods and techniques described herein.

In some implementations, the allocation platform is integrated as a native application within cloud-based data warehousing platforms. By integrating the allocation platform, users can leverage advanced artificial intelligence capabilities seamlessly within existing data warehousing and analytics environments. This integration can enhance data processing efficiency, enable more sophisticated data analysis, and provide real-time insights without the need for external tools or complex data migrations. Furthermore, this integration can streamline workflows, reduce latency, and improve overall data management and decision-making processes.

In some implementations, the allocation platform is deployed as a Deal ID within a Supply-Side Platform (SSP). A Deal ID can be a unique identifier that facilitates private marketplace transactions between buyers and sellers, ensuring that specific terms and conditions are met. By implementing the allocation platform in this manner, the platform can be used to manage and optimize the buying and selling of digital advertising inventory. Integrating the allocation platform as a Deal ID within an SSP can enhance the efficiency and effectiveness of ad transactions by providing more precise targeting, better inventory management, and improved transparency. In some implementations, the allocation platform is fully integrated into RTB environments. This integration can enable the allocation platform to make instant decisions about bid adjustments based on dynamic inputs such as real-time inventory availability, audience behavior, and budget constraints. This integration can allow the allocation platform to process and analyze these inputs in real-time, facilitating microsecond-level decision-making within RTB auctions.

In some implementations, the allocation platform applies to other environments, as well. For example the allocation platform’s capabilities can be expanded to allocate budgets across new dimensions, such as per Supply Vendor (e.g., specific platforms or content providers) or Audience ID (e.g., targeting different user groups based on audience segmentation), can offer even finer control over resource allocation. This enhancement can allow advertisers to optimize their campaigns across a broader set of variables beyond traditional ad groups or regions. By allocating budgets based on specific supply vendors, advertisers can tailor their spending to the performance and characteristics of individual platforms or content providers. Similarly, targeting different user groups based on audience segmentation can enable more precise and effective ad delivery, ensuring that the right messages reach the right audiences. This expanded capability can lead to improved campaign performance, better ROI, and more strategic use of advertising resources.

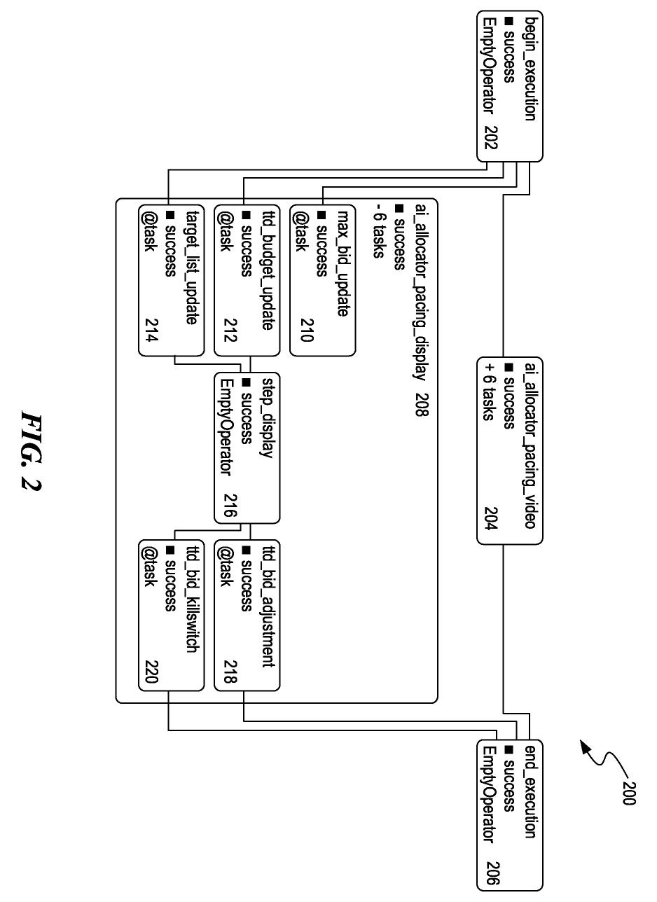

FIG. 2 shows an example workflow 200 for the allocation platform in accordance with some implementations of the present technology. The workflow 200 can begin with step 202, which is the begin_execution step, and which can be marked as successful. Step 202 can signify the initiation of the workflow. In some implementations, step 202 involves an EmptyOperator. The EmptyOperator can refer to a placeholder or a no-operation task within the workflow 200. This operator can indicate that at certain points in the execution sequence, there are steps that do not perform specific actions but are included to maintain the structure or flow of the process. These empty operators can be useful for debugging, organizing tasks, or ensuring that the workflow adheres to a specific format. As an illustrative example, the workflow can begin, at step 202, by ingesting a budget sheet containing target variables, daily budgets, and bidding instructions for ad groups.

Following the initiation, the workflow 200 can proceed to step 204. At step 204, the ai_allocator_pacing_video can be executed successfully. Step 204 can add six tasks related to video pacing, indicating the allocation platform’s capability to manage and allocate videos efficiently. The workflow 200 proceeds from step 204 to step 206, the end_execution step, which can be marked as successful and can involve an EmptyOperator. Step 206 can signify the successful completion of the allocation process.

In some implementations, the workflow can proceed from step 202 to step 208. At step 208, the ai_allocator_pacing_display task can be executed successfully, adding six tasks related to display pacing. This demonstrates the allocation platform’s ability to handle displays with proper pacing. The workflow 200 can then proceed to step 210, the max_bid_update task, which can be executed successfully and can be marked with “@task,” indicating it is a specific task within the workflow. This task can update the maximum bid values. Following step 210, at step 212, the ttd_budget_update task can be executed successfully, also marked with “@task.” This task can update the budget allocations for different advertisements. As an illustrative example, the allocation platform can create tasks such as ttd_budget_update (e.g., step 212), which can translate monthly budgets into daily and hourly targets. These tables can also hold configurations, including bidding instructions and pacing instructions. Real-time bidding data can be crucial for monitoring spend across different variables. In some implementations, every 15 minutes, the allocation platform compares actual spend against pre-calculated budgets.

Next, at step 214, the target_list_update task can be executed successfully and can be marked with “@task.” This task can involve updating the target list, ensuring that the allocations reach the intended audience. At step 216, the step_display step can be executed successfully and can cause display of bids, updated budgets, updated target lists, or other information. This step can involve an EmptyOperator, which can serve as a placeholder or a step in the workflow 200.

The workflow can include step 218, the ttd_bid_adjustment task, which can be executed successfully and can be marked with “@task.” This task can involve adjusting the bid values based on various factors, as previously discussed. In some implementations, at step 220, the ttd_bid_killswitch task can be executed successfully and can be marked with “@task.” This task can be a safety mechanism to halt bidding under certain conditions, as previously discussed. As an illustrative example, when features approach or exceed their daily budget, they can be added to a blocklist via the ttd_bid_killswitch task (e.g., step 220), preventing further spend for those features. Simultaneously, the ttd_bid_adjustment task (e.g., step 218) compares hourly spend against the budget, adjusting bids up or down based on whether a feature is over- or under-pacing.

In some embodiments, the allocation platform leverages a set of configurable bidding logic, derived from the Spline Regression algorithms to ensure that bids remain within predefined ranges and are adjusted appropriately in response to intra-day data signals. As an illustrative example, the allocation platform can receive recommended bids, which can include set maximums. In some implementations, third-party platforms have set minimums. These maximums or minimums can change throughout the course of a campaign. In some implementations, it is advantageous for the allocation platform to lower the maximum to ensure overall performance of a given campaign. The algorithms must be able to adapt to these new constraints quickly. Bid lists (e.g., a form in which a platform will accept modeled decisions on what to bid when an openRTB auction opportunity is presented) can be uploaded to the platform through API integrations. The non-convex optimization theory and time-series forecasting models can be operationalized through these tasks to automate bid adjustments, blocklist updates, and pacing corrections (e.g., every 15 minutes). Additionally, the allocation platform can be manually triggered, for example, when mid-flight budget updates are necessary, allowing it to recalculate budgets and update accordingly. To ensure robustness, the allocation platform logs every action, tracking which variables are blocked or optimized during the campaign.

Finally, the workflow can conclude with step 206, the end_execution step, which can be marked as successful and can involve an EmptyOperator. Step 206 can signify the successful completion of the allocation process. Overall, the workflow can include a series of tasks related to allocation, pacing, budget updates, bid adjustments, and a killswitch mechanism, any of which can be executed successfully according to various conditions.

Workflows such as workflow 200 allow the allocation platform to implement its algorithms in a scalable, flexible manner that ensures optimal bid distribution across multiple campaigns and platforms. This real-time system provides granular control over pacing and bid management, adhering to the high-level objectives of maximizing performance while staying within budgetary constraints.

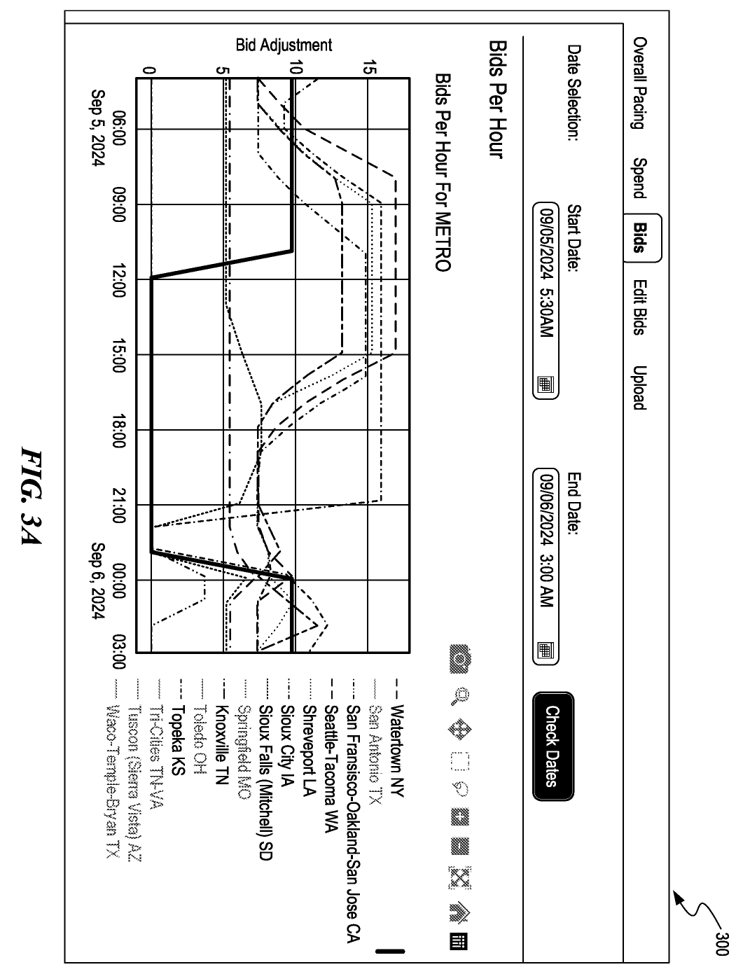

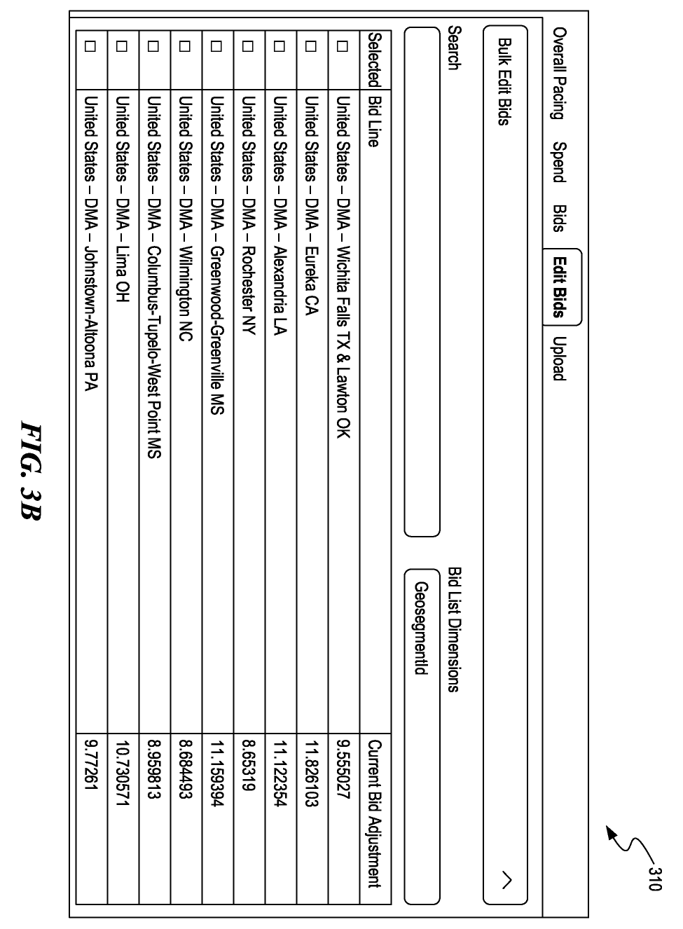

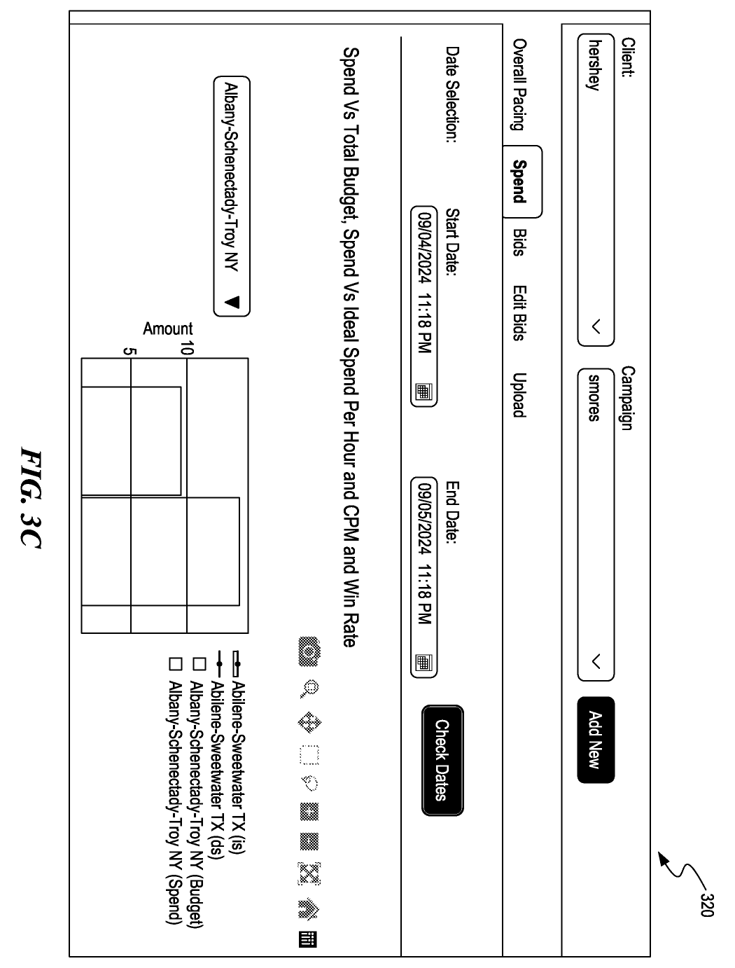

FIG. 3A shows an example GUI 300 that demonstrates aspects of bid trends associated with the allocation platform in accordance with some implementations of the present technology. In some implementations, GUI 300 illustrates the bids of an allocation platform over a specified period. The interface allows users to select a date range, with GUI 300 showing a start date of September 4, 2024, at 11:18 PM and an end date of September 5, 2024, at 11:18 PM. This feature enables users to analyze bids within a precise timeframe, ensuring that the data is relevant and specific to their needs.

GUI 300 provides a detailed breakdown of bids per hour for various metropolitan areas. These areas include Watertown, NY; San Antonio, TX; San Francisco-Oakland-San Jose, CA; Seattle-Tacoma, WA; Shreveport, LA; Sioux City, IA; Sioux Falls (Mitchell), SD; Springfield, MO; Knoxville, TN; Toledo, OH; Topeka, KS; Tri-Cities, TN-VA; Tucson (Sierra Vista), AZ; and Waco-Temple-Bryan, TX. This geographical segmentation allows users to compare and contrast the bidding activity across different regions, which can be crucial for understanding regional demand and allocation strategies. In some implementations, GUI 300 enables selection by the user of areas of interest. For example, GUI 300 receives, from the user, selections of Watertown, NY; San Francisco-Oakland-San Jose, CA; Seattle-Tacoma, WA; Shreveport, LA; Sioux City, IA; Sioux Falls (Mitchell), SD; Knoxville, TN; and Topeka, KS. GUI 300 can then display the bids per hour for these selected areas.

The timeline on GUI 300 spans from September 5, 2024, at 5:30 AM to September 6, 2024, at 3:00 AM, with data points marked at three-hour intervals. This hourly breakdown provides a view of the bidding activity, enabling users to identify peak times and trends in the allocation process. The bid adjustment scale, ranging from 0 to 30, indicates the average bid price during these intervals, offering a clear visual representation of the data. In some implementations, the allocation platform displays a more granular view of bidding activity for shorter time ranges and a higher overview of bidding activity for longer time ranges. In some implementations, other views of bidding activity are provided by GUI 300.

FIG. 3B shows an example GUI 310 that demonstrates aspects of current bids of the allocation platform in accordance with some implementations of the present technology. In some implementations, GUI 310 enables managing and editing of bids. The interface can be structured to provide users with a comprehensive overview of current bidding strategies and allow for detailed adjustments across various geographic regions. This functionality can enable users to optimize allocation of resources and ensure that bids are competitive and effective.

In some implementations, the “Bulk Edit Bids” option enables users to make widespread changes to multiple bids simultaneously. This can be particularly useful for managing large-scale campaigns. GUI 310 can also include options for users to edit individual bids directly within the table. This feature provides a high level of control and precision, enabling users to make targeted adjustments based on real-time data and performance metrics. By offering both granular and bulk editing capabilities, the platform ensures that users have the flexibility to manage their bids in a way that aligns with their overall strategy and objectives.

GUI 310 can also feature a search bar and a list of bids. In some implementations, GUI 310 enables a user to select a dimension through which to view the list of bids, including geographic region IDs. The list can be organized in a tabular format, with columns for the selected status, bid line, and current bid adjustment values. For example, the bid adjustments for various areas in the United States are displayed, such as Wichita Falls, TX & Lawton, OK with a bid adjustment of 9.555027, and Eureka, CA with a bid adjustment of 11.826103. This detailed breakdown can allow users to fine-tune their bids based on specific geographic segments, ensuring that resources are allocated efficiently.

FIG. 3C shows an example GUI 320 that demonstrates aspects of a pacing dashboard of the allocation platform in accordance with some implementations of the present technology. In some implementations, GUI 320 can be used to monitor and manage spending on allocations within a specified date range. The interface can be designed to help users track and optimize their allocation budgets effectively. The client in the example shown in FIG. 3C is Hershey, and the campaign being monitored is labeled “smores.” These illustrative allocations can be a part of a broader initiative aimed at promoting a specific product or theme.

In some implementations, GUI 320 includes several features that facilitate detailed tracking and management of allocation spending. The date selection tool enables users to specify a start and end date for the data the users wish to analyze. In this example, the selected date range is from September 4, 2024, at 11:18 PM to September 5, 2024, at 11:18 PM. The interface provides a detailed breakdown for the specified range. For example, the interview provides an illustration of spending versus the total budget, ideal spend per hour, CPM, and win rate. These metrics can enable users to visualize how effectively the allocations are performing and where adjustments can be needed. For instance, if the spend is significantly higher than the ideal spend per hour, it can indicate that the budget is being exhausted too quickly, necessitating a reevaluation of the allocation strategy.

Additionally, the GUI 320 can list specific geographic locations such as Albany-Schenectady-Troy, NY, and Abilene-Sweetwater, TX, with corresponding budget and spend amounts. This level of granularity allows users to view how different regions are performing and allocate resources accordingly. For example, if Albany-Schenectady-Troy, NY, is underperforming in terms of spend versus budget, the allocation platform reallocates funds to more promising areas. In some implementations, the allocation platform adjusts the approach in that region. In some implementations, the allocation platform invests additional resources into underperforming areas in order to improve performance in those areas.

### Example Methods of Operation of the Allocation Platform

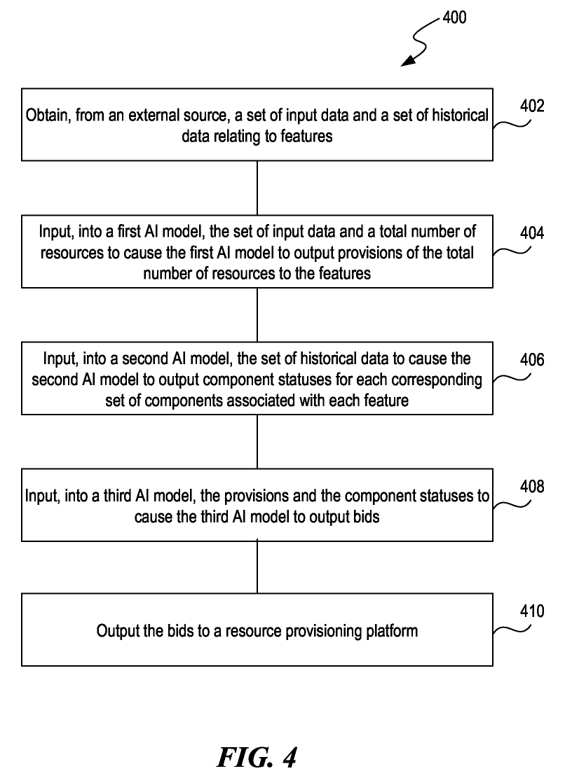

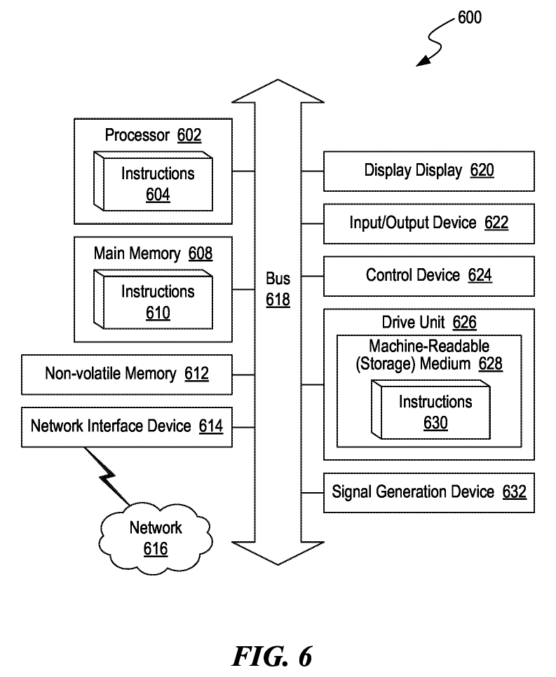

FIG. 4 is a flowchart depicting an example method 400 of operation of the allocation platform 102 of FIGS. 1A and 1B, in accordance with some implementations of the present technology. In some implementations, the method 400 is performed by components of the example computer system 600 illustrated and described in more detail with reference to FIG. 6. Likewise, implementations can include different and/or additional operations or can perform the operations in different orders.

In operation 402, the allocation platform 102 obtains, from an external source, a set of input data (e.g., external data 104 in FIGS. 1A and 1B) and a set of historical data (e.g., external data 105 in FIG. 1B). The input data and historical data can relate to features, such as geographical regions to which resources are to be allocated. The input data and the historical data can be normalized to ensure comparability across different units. For example, data is adjusted to a common scale or format, eliminating any discrepancies caused by varying units of measurement or differing data ranges. This process can involve transforming the data so that it can be compared and analyzed consistently, regardless of its original format. The data can be structured or unstructured. Structured data can be organized and searchable and can be stored in databases with defined fields. On the other hand, unstructured data lacks a predefined format. In some implementations, unstructured data is converted into structured data before it is used. In some implementations, the allocation platform standardizes online and offline data to be processed by the allocation platform. This process can encompass Natural Language Processing (NLP) analysis and sentiment analysis of certain data types. The standardized data can be structured in a specific format, such as a CSV file containing certain fields, including value.

In operation 404, the allocation platform inputs, into a first AI model (e.g., algorithm module 106 in FIGS. 1A and 1B), the set of input data and a total number of resources to cause the first AI model to output provisions of the total number of resources to the features. For example, the trained AI model is configured to output resource provisioning among features. The training process can involve feeding the model large datasets that represent different scenarios and outcomes, allowing it to learn patterns and relationships between the input data and the desired allocation outcomes. Techniques such as supervised learning, in which the model is trained on labeled data with known outcomes, and reinforcement learning, where the model learns by receiving feedback on its actions, can be employed to enhance the model’s accuracy and effectiveness.

In operation 406, the allocation platform inputs, into a second AI model (e.g., forecasting module 112 in FIG. 1B), the set of historical data to cause the second AI model to output component statuses for each corresponding set of components associated with each feature. For example, each component is a product offered at a particular location, and a component status can indicate whether that product is available at that particular location. Examples of component statues can include available, not available, backordered, discontinued, or other statuses. In some implementations, the second trained AI model is trained to predict statuses of components based on historical data. The second trained AI model can use time series forecasting, incorporating statistical techniques such as AutoRegressive Integrated Moving Average (ARIMA) and other models to handle both linear and non-linear trends. While ARIMA is particularly effective for linear trends, the allocation platform can integrate other forecasting models for non-linear patterns in the data. By employing ETS alongside ARIMA, the allocation platform adapts to both linear and non-linear trends, ensuring robust forecasting across different market conditions. The second trained AI model can apply these techniques to predict, or forecast, expected inventory availability per feature, enabling precise budget pacing and bid optimization. The second trained AI model can generate hourly forecasts of inventory availability for the campaign duration. These predictions can be iteratively updated, allowing the allocation platform to adapt to new data and market trends and ensuring optimal performance in real-time.

In operation 408, the allocation platform inputs, into a third AI model (e.g., bid optimization module 114 in FIG. 1B), the provisions and the component statuses to cause the third AI model to output bids. For example, the third trained AI model is configured to output bids based on provisioning and component statuses. To determine bids, the third trained AI model can determine non-convex optimization. Non-convex optimization problems are characterized by objective functions that can have multiple local minima and maxima, making the search for the global minimum more challenging. The objective of the third trained AI model can be to minimize the cost per thousand impressions (CPM) while ensuring full delivery of the allocated budget in each selected feature. The third trained AI model can attempt to minimize a function subject to constraints on budget and inventory availability.

In operation 410, the allocation platform outputs the bids to a resource provisioning platform (e.g., platform upload module 108 in FIG. 1A or platform upload module 116 in FIG. 1B). The allocation platform can interact with platform upload procedures through various interfaces, including REST APIs, GraphQL APIs, and Robotic Process Automation (RPA). These interactions can facilitate the efficient transfer and updating of data across different platforms, ensuring that the allocation platform remains synchronized and up-to-date. Furthermore, the platform can support integration with other systems, facilitating seamless data exchange and enhancing operational efficiency. For example, the allocation platform integrates into external platforms, providing them with information through Application Programming Interfaces (APIs), Spline Font Database (SFD), and other data exchange formats. This integration allows for iterative feedback looping, as data from the external platforms can be fed back into the allocation platform to refine and optimize future resource provisions. This continuous feedback loop ensures that the allocation platform remains responsive to changing conditions and can dynamically adjust resource allocations in real-time.

### Example Implementation of the Model of the Allocation Platform

FIG. 5 illustrates a layered architecture of an AI system 500 that can implement the ML models of the allocation platform 102 of FIGS. 1A and 1B, in accordance with some implementations of the present technology. Example ML models can include the models executed by the algorithm module 106. Accordingly, the algorithm module 106 can include one or more components of the AI system 500.

As shown, the AI system 500 can include a set of layers, which conceptually organize elements within an example network topology for the AI system’s architecture to implement a particular AI model. Generally, an AI model is a computer-executable program implemented by the AI system 500 that analyses data to make predictions. Information can pass through each layer of the AI system 500 to generate outputs for the AI model. The layers can include a data layer 502, a structure layer 504, a model layer 506, and an application layer 508. The algorithm 516 of the structure layer 504 and the model structure 520 and model parameters 522 of the model layer 506 together form an example AI model. The optimizer 526, loss function engine 524, and regularization engine 528 work to refine and optimize the AI model, and the data layer 502 provides resources and support for application of the AI model by the application layer 508.

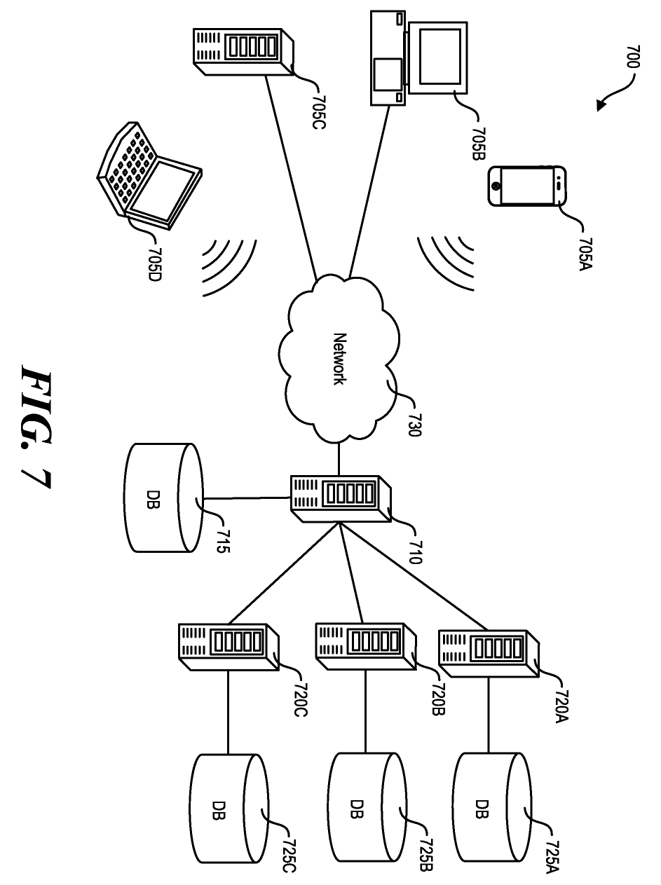

The data layer 502 acts as the foundation of the AI system 500 by preparing data for the AI model. As shown, the data layer 502 can include two sub-layers: a hardware platform 510 and one or more software libraries 512. The hardware platform 510 can be designed to perform operations for the AI model and include computing resources for storage, memory, logic and networking, such as the resources described in relation to FIGS. 6 and 7. The hardware platform 510 can process amounts of data using one or more servers. The servers can perform backend operations such as matrix calculations, parallel calculations, ML training, and the like. Examples of servers used by the hardware platform 510 include central processing units (CPUs) and graphics processing units (GPUs). CPUs are electronic circuitry designed to execute instructions for computer programs, such as arithmetic, logic, controlling, and input/output (I/O) operations, and can be implemented on integrated circuit (IC) microprocessors. GPUs are electric circuits that were originally designed for graphics manipulation and output but can be used for AI applications due to their vast computing and memory resources. GPUs use a parallel structure that generally makes their processing more efficient than that of CPUs. In some instances, the hardware platform 510 can include computing resources, (e.g., servers, memory, etc.) offered by a cloud services provider. The hardware platform 510 can also include computer memory for storing data about the AI model, application of the AI model, and training data for the AI model. The computer memory can be a form of random-access memory (RAM), such as dynamic RAM, static RAM, and non-volatile RAM.

The software libraries 512 can be thought of suites of data and programming code, including executables, used to control the computing resources of the hardware platform 510. The programming code can include low-level primitives (e.g., fundamental language elements) that form the foundation of one or more low-level programming languages, such that servers of the hardware platform 510 can use the low-level primitives to carry out specific operations. The low-level programming languages do not require much, if any, abstraction from a computing resource’s instruction set architecture, allowing them to run quickly with a small memory footprint. Examples of software libraries 512 that can be included in the AI system 500 include INTEL Math Kernel Library, NVIDIA cuDNN, EIGEN, and OpenBLAS.

The structure layer 504 can include an ML framework 514 and an algorithm 516. The ML framework 514 can be thought of as an interface, library, or tool that allows users to build and deploy the AI model. The ML framework 514 can include an open-source library, an API, a gradient-boosting library, an ensemble method, and/or a deep learning toolkit that work with the layers of the AI system facilitate development of the AI model. For example, the ML framework 514 distributes processes for application or training of the AI model across multiple resources in the hardware platform 510. The ML framework 514 can also include a set of pre-built components that have the functionality to implement and train the AI model and allow users to use pre-built functions and classes to construct and train the AI model. Thus, the ML framework 514 can be used to facilitate data engineering, development, hyperparameter tuning, testing, and training for the AI model. Examples of ML frameworks 514 that can be used in the AI system 500 include TENSORFLOW, PYTORCH, SCIKIT-LEARN, KERAS, LightGBM, RANDOM FOREST, and AMAZON WEB SERVICES.

The algorithm 516 can be an organized set of computer-executable operations used to generate output data from a set of input data and can be described using pseudocode. The algorithm 516 can include complex code that allows the computing resources to learn from new input data and create new/modified outputs based on what was learned. In some implementations, the algorithm 516 can build the AI model through being trained while running computing resources of the hardware platform 510. This training allows the algorithm 516 to make predictions or decisions without being explicitly programmed to do so. Once trained, the algorithm 516 can run at the computing resources as part of the AI model to make predictions or decisions, improve computing resource performance, or perform tasks. The algorithm 516 can be trained using supervised learning, unsupervised learning, semi-supervised learning, and/or reinforcement learning.

Using supervised learning, the algorithm 516 can be trained to learn patterns (e.g., map input data to output data) based on labeled training data. The training data can be labeled by an external user or operator. For instance, a user can collect a set of training data, such as by capturing data from sensors, images from a camera, outputs from a model, and the like. In an example implementation, training data can include native-format data collected from various source computing systems described in relation to FIGS. 1A and 1B. Furthermore, training data can include pre-processed data generated by various engines of the allocation platform 102 described in relation to FIGS. 1A and 1B. The user can label the training data based on one or more classes and trains the AI model by inputting the training data to the algorithm 516. The algorithm determines how to label the new data based on the labeled training data. The user can facilitate collection, labeling, and/or input via the ML framework 514. In some instances, the user can convert the training data to a set of feature vectors for input to the algorithm 516. Once trained, the user can test the algorithm 516 on new data to determine if the algorithm 516 is predicting accurate labels for the new data. For example, the user uses cross-validation methods to test the accuracy of the algorithm 516 and retrain the algorithm 516 on new training data if the results of the cross-validation are below an accuracy threshold.

Supervised learning can involve classification and/or regression. Classification techniques involve teaching the algorithm 516 to identify a category of new observations based on training data and are used when input data for the algorithm 516 is discrete. Said differently, when learning through classification techniques, the algorithm 516 receives training data labeled with categories (e.g., classes) and determines how features observed in the training data (e.g., various claim elements, policy identifiers, tokens extracted from unstructured data) relate to the categories (e.g., risk propensity categories, claim leakage propensity categories, complaint propensity categories). Once trained, the algorithm 516 can categorize new data by analyzing the new data for features that map to the categories. Examples of classification techniques include boosting, decision tree learning, genetic programming, learning vector quantization, k-nearest neighbor (k-NN) algorithm, and statistical classification.

Regression techniques involve estimating relationships between independent and dependent variables and are used when input data to the algorithm 516 is continuous. Regression techniques can be used to train the algorithm 516 to predict or forecast relationships between variables. To train the algorithm 516 using regression techniques, a user can select a regression method for estimating the parameters of the model. The user collects and labels training data that is input to the algorithm 516 such that the algorithm 516 is trained to understand the relationship between data features and the dependent variable(s). Once trained, the algorithm 516 can predict missing historic data or future outcomes based on input data. Examples of regression methods include linear regression, multiple linear regression, logistic regression, regression tree analysis, least squares method, and gradient descent. In an example implementation, regression techniques can be used, for example, to estimate and fill-in missing data for machine-learning based pre-processing operations.

Under unsupervised learning, the algorithm 516 learns patterns from unlabeled training data. In particular, the algorithm 516 is trained to learn hidden patterns and insights of input data, which can be used for data exploration or for generating new data. Here, the algorithm 516 does not have a predefined output, unlike the labels output when the algorithm 516 is trained using supervised learning. Said another way, unsupervised learning is used to train the algorithm 516 to find an underlying structure of a set of data, group the data according to similarities, and represent that set of data in a compressed format. The allocation platform 102 can use unsupervised learning to identify patterns in claim history (e.g., to identify particular event sequences) and so forth. In some implementations, performance of the algorithm module 106 that can use unsupervised learning is improved because the incoming data from the external data 104 is pre-processed and reduced, based on the relevant triggers, as described herein.

A few techniques can be used in supervised learning: clustering, anomaly detection, and techniques for learning latent variable models. Clustering techniques involve grouping data into different clusters that include similar data, such that other clusters contain dissimilar data. For example, during clustering, data with possible similarities remain in a group that has less or no similarities to another group. Examples of clustering techniques density-based methods, hierarchical based methods, partitioning methods, and grid-based methods. In one example, the algorithm 516 can be trained to be a k-means clustering algorithm, which partitions n observations in k clusters such that each observation belongs to the cluster with the nearest mean serving as a prototype of the cluster. Anomaly detection techniques are used to detect previously unseen rare objects or events represented in data without prior knowledge of these objects or events. Anomalies can include data that occur rarely in a set, a deviation from other observations, outliers that are inconsistent with the rest of the data, patterns that do not conform to well-defined normal behavior, and the like. When using anomaly detection techniques, the algorithm 516 can be trained to be an Isolation Forest, local outlier factor (LOF) algorithm, or k-NN algorithm. Latent variable techniques involve relating observable variables to a set of latent variables. These techniques assume that the observable variables are the result of an individual’s position on the latent variables and that the observable variables have nothing in common after controlling for the latent variables. Examples of latent variable techniques that can be used by the algorithm 516 include factor analysis, item response theory, latent profile analysis, and latent class analysis.

The model layer 506 implements the AI model using data from the data layer and the algorithm 516 and ML framework 514 from the structure layer 504, thus enabling decision-making capabilities of the AI system 500. The model layer 506 includes a model structure 520, model parameters 522, a loss function engine 524, an optimizer 526, and a regularization engine 528.

The model structure 520 describes the architecture of the AI model of the AI system 500. The model structure 520 defines the complexity of the pattern/relationship that the AI model expresses. Examples of structures that can be used as the model structure 520 include decision trees, support vector machines, regression analyses, Bayesian networks, Gaussian processes, genetic algorithms, and artificial neural networks (or, simply, neural networks). The model structure 520 can include a number of structure layers, a number of nodes (or neurons) at each structure layer, and activation functions of each node. Each node’s activation function defines how to node converts data received to data output. The structure layers can include an input layer of nodes that receive input data, an output layer of nodes that produce output data. The model structure 520 can include one or more hidden layers of nodes between the input and output layers. The model structure 520 can be an Artificial Neural Network (or, simply, neural network) that connects the nodes in the structured layers such that the nodes are interconnected. Examples of neural networks include Feedforward Neural Networks, convolutional neural networks (CNNs), Recurrent Neural Networks (RNNs), Autoencoder, and Generative Adversarial Networks (GANs).

The model parameters 522 represent the relationships learned during training and can be used to make predictions and decisions based on input data. The model parameters 522 can weight and bias the nodes and connections of the model structure 520. For instance, when the model structure 520 is a neural network, the model parameters 522 can weight and bias the nodes in each layer of the neural networks, such that the weights determine the strength of the nodes and the biases determine the thresholds for the activation functions of each node. The model parameters 522, in conjunction with the activation functions of the nodes, determine how input data is transformed into desired outputs. The model parameters 522 can be determined and/or altered during training of the algorithm 516.

The loss function engine 524 can determine a loss function, which is a metric used to evaluate the AI model’s performance during training. For instance, the loss function engine 524 can measure the difference between a predicted output of the AI model and the actual output of the AI model and is used to guide optimization of the AI model during training to minimize the loss function. The loss function can be presented via the ML framework 514, such that a user can determine whether to retrain or otherwise alter the algorithm 516 if the loss function is over a threshold. In some instances, the algorithm 516 can be retrained automatically if the loss function is over the threshold. Examples of loss functions include a binary-cross entropy function, hinge loss function, regression loss function (e.g., mean square error, quadratic loss, etc.), mean absolute error function, smooth mean absolute error function, log-cosh loss function, and quantile loss function.

The optimizer 526 adjusts the model parameters 522 to minimize the loss function during training of the algorithm 516. In other words, the optimizer 526 uses the loss function generated by the loss function engine 524 as a guide to determine what model parameters lead to the most accurate AI model. Examples of optimizers include Gradient Descent (GD), Adaptive Gradient Algorithm (AdaGrad), Adaptive Moment Estimation (Adam), Root Mean Square Propagation (RMSprop), Radial Base Function (RBF) and Limited-memory BFGS (L-BFGS). The type of optimizer 526 used can be determined based on the type of model structure 520 and the size of data and the computing resources available in the data layer 502.

The regularization engine 528 executes regularization operations. Regularization is a technique that prevents over- and under-fitting of the AI model. Overfitting occurs when the algorithm 516 is overly complex and too adapted to the training data, which can result in poor performance of the AI model. Underfitting occurs when the algorithm 516 is unable to recognize even basic patterns from the training data such that it cannot perform well on training data or on validation data. The optimizer 526 can apply one or more regularization techniques to fit the algorithm 516 to the training data properly, which helps constraint the resulting AI model and improves its ability for generalized application. Examples of regularization techniques include lasso (L1) regularization, ridge (L2) regularization, and elastic (L1 and L2 regularization).

The application layer 508 describes how the AI system 500 is used to solve problem or perform tasks. In an example implementation, the application layer 508 can include the platform upload of the allocation platform 102.

### Example Computing Environment of the Allocation Platform

FIG. 6 is a block diagram showing some of the components typically incorporated in at least some of the computer system 600 on which the disclosed system operates in accordance with some implementations of the present technology. As shown, an example computer system 600 can include: one or more processors 602, main memory 608, non-volatile memory 612, a network interface device 614, video display device 620, an input/output device 622, a control device 624 (e.g., keyboard and pointing device), a drive unit 626 that includes a machine-readable medium 628, and a signal generation device 632 that are communicatively connected to a bus 618. The bus 618 represents one or more physical buses and/or point-to-point connections that are connected by appropriate bridges, adapters, or controllers. Various common components (e.g., cache memory) are omitted from FIG. 6 for brevity. Instead, the computer system 600 is intended to illustrate a hardware device on which components illustrated or described relative to the examples of the figures and any other components described in this specification can be implemented.

The computer system 600 can take any suitable physical form. For example, the computer system 600 shares a similar architecture to that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computer system 600. In some implementations, the computer system 600 can be an embedded computer system, a system-on-chip (SOC), a single-board computer system (SBC) or a distributed system such as a mesh of computer systems or include one or more cloud components in one or more networks. Where appropriate, one or more computer systems 600 can perform operations in real-time, near real-time, or in batch mode.

The network interface device 614 enables the computer system 600 to exchange data in a network 616 with an entity that is external to the computing system 600 through any communication protocol supported by the computer system 600 and the external entity. Examples of the network interface device 614 include a network adaptor card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 608, non-volatile memory 612, machine-readable medium 628) can be local, remote, or distributed. Although shown as a single medium, the machine-readable medium 628 can include multiple media (e.g., a centralized/distributed database and/or associated caches and servers) that store one or more sets of instructions 630. The machine-readable (storage) medium 628 can include any medium that is capable of storing, encoding, or carrying a set of instructions for execution by the computer system 600. The machine-readable medium 628 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory, removable memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 604, 610, 630) set at various times in various memory and storage devices in computing device(s). When read and executed by the processor 602, the instruction(s) cause the computer system 600 to perform operations to execute elements involving the various aspects of the disclosure.

FIG. 7 is a system diagram illustrating an example of a computing environment in which the disclosed system operates in some implementations. In some implementations, environment 700 includes one or more client computing devices 705A-D, examples of which can host the allocation platform 102 of FIGS. 1A and 1B. Client computing devices 705 operate in a networked environment using logical connections through network 730 to one or more remote computers, such as a server computing device.

In some implementations, server 710 is an edge server which receives client requests and coordinates fulfillment of those requests through other servers, such as servers 720A-C. In some implementations, server computing devices 710 and 720 comprise computing systems, such as the allocation platform 102 of FIGS. 1A and 1B. Though each server computing device 710 and 720 is displayed logically as a single server, server computing devices can each be a distributed computing environment encompassing multiple computing devices located at the same or at geographically disparate physical locations. In some implementations, each server 720 corresponds to a group of servers.

Client computing devices 705 and server computing devices 710 and 720 can each act as a server or client to other server or client devices. In some implementations, servers (710, 720A-C) connect to a corresponding database (715, 725A-C). As discussed above, each server 720 can correspond to a group of servers, and each of these servers can share a database or can have its own database. Databases 715 and 725 warehouse (e.g., store) information such as claims data, email data, call transcripts, call logs, policy data and so on. Though databases 715 and 725 are displayed logically as single units, databases 715 and 725 can each be a distributed computing environment encompassing multiple computing devices, can be located within their corresponding server, or can be located at the same or at geographically disparate physical locations.

Network 730 can be a local area network (LAN) or a wide area network (WAN), but can also be other wired or wireless networks. In some implementations, network 730 is the Internet or some other public or private network. Client computing devices 705 are connected to network 730 through a network interface, such as by wired or wireless communication. While the connections between server 710 and servers 720 are shown as separate connections, these connections can be any kind of local, wide area, wired, or wireless network, including network 730 or a separate public or private network.

### Conclusion

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number can also include the plural or singular number respectively. The word “or,” in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations can perform routines having steps, or employ systems having blocks, in a different order, and some processes or blocks can be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples: alternative implementations can employ differing values or ranges.

The teachings of the technology provided herein can be applied to other systems, not necessarily the system described above. The elements and acts of the various examples described above can be combined to provide further implementations of the technology. Some alternative implementations of the technology include not only additional elements to those implementations noted above, but also can include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system can vary considerably in its specific implementation, while still being encompassed by the technology disclosed herein. As noted above, specific terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects can likewise be embodied as a computer-readable medium claim, or in other forms, such as being embodied in a means-plus-function claim. Any claims intended to be treated under 35 U.S.C. § 112(f) will begin with the words “means for,” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

We claim:

1. A computer-implemented method for provisioning resources to features using artificial intelligence (AI) models, the computer-implemented method comprising:
obtaining data for a plurality of features, wherein each feature of the plurality of features is associated with a corresponding set of components having a plurality of component statuses;
determining a plurality of provisions of a total number of resources to provision among the plurality of features;
inputting, into a trained AI system, the obtained data and the plurality of provisions to cause the trained AI system to output a plurality of bids associated with the plurality of features and corresponding sets of components;
determining a performance metric for the plurality of bids, wherein the performance metric indicates a current performance value of the plurality of bids;
applying a modification to the plurality of bids to generate a plurality of modified bids, wherein the modification is based on the performance metric; and
outputting the plurality of modified bids to a resource provisioning platform.

2. The computer-implemented method of claim 1, wherein the performance metric indicates a projected future performance of the plurality of bids.

3. The computer-implemented method of claim 2, wherein the modification is further based on a pace at which the total number of resources are to be provisioned among the plurality of features.

4. The computer-implemented method of claim 2, further comprising:
detecting a feedback trigger, wherein the feedback trigger comprises a change in the total number of resources, a passage of a predetermined amount of time, or an occurrence of a predetermined event; and
responsive to detecting the feedback trigger:
inputting, into the trained AI system, the plurality of modified bids to cause the trained AI system to output a plurality of updated bids; and
outputting the plurality of updated bids to the resource provisioning platform.

5. The computer-implemented method of claim 1, further comprising:
determining one or more parameters based on one or more regulations for sets of data; and
filtering the obtained data according to the one or more parameters.

6. The computer-implemented method of claim 1, further comprising:
determining a plurality of updated component statuses;
inputting, into the trained AI system, the plurality of provisions and the plurality of updated component statuses to cause the trained AI system to output a plurality of updated bids; and
outputting the plurality of updated bids to the resource provisioning platform.

7. The computer-implemented method of claim 1, further comprising:
detecting an excess provisioning trigger, wherein the excess provisioning trigger comprises an indication of excess resource provisioning within a predetermined time period; and
responsive to detecting the excess provisioning trigger, causing the plurality of bids to terminate.

8. One or more non-transitory, computer-readable storage media storing instructions for provisioning resources to features, wherein the instructions when executed by at least one data processor of a computing system, cause the computing system to:
obtain, from an external source, data comprising a plurality of features;
determine a plurality of provisions of a total number of resources to provision among the plurality of features;
input, into a trained AI system, the obtained data and the plurality of provisions to cause the trained AI system to output a plurality of bids associated with the plurality of features; and
output the plurality of bids to a resource provisioning platform.

9. The one or more non-transitory, computer-readable storage media of claim 8, wherein the instructions further cause the computing system to:
determine a performance metric for the plurality of bids, wherein the performance metric indicates a current performance value of the plurality of bids or a projected future performance of the plurality of bids;
apply a modification to the plurality of bids to generate a plurality of modified bids, wherein the modification is based on the performance metric; and
output the plurality of modified bids to the resource provisioning platform.

10. The one or more non-transitory, computer-readable storage media of claim 9, wherein the modification is further based on a pace at which the total number of resources are to be provisioned among the plurality of features.

11. The one or more non-transitory, computer-readable storage media of claim 9, wherein the instructions further cause the computing system to:
responsive to detecting a feedback trigger, wherein the feedback trigger comprises a change in the total number of resources, a passage of a predetermined amount of time, or an occurrence of a predetermined event:
input, into the trained AI system, the plurality of modified bids to cause the trained AI system to output a plurality of updated bids; and
output the plurality of updated bids to the resource provisioning platform.

12. The one or more non-transitory, computer-readable storage media of claim 8, wherein the instructions further cause the computing system to:
determine one or more parameters based on one or more regulations for sets of data; and
filter the obtained data according to the one or more parameters.

13. The one or more non-transitory, computer-readable storage media of claim 8, wherein the instructions further cause the computing system to:
determine a plurality of updated component statuses;
input, into the trained AI system, the plurality of provisions and the plurality of updated component statuses to cause the trained AI system to output a plurality of updated bids; and
output the plurality of updated bids to the resource provisioning platform.

14. The one or more non-transitory, computer-readable storage media of claim 8, wherein the instructions further cause the computing system to, responsive to detecting an excess provisioning trigger, cause the plurality of bids to terminate, wherein the excess provisioning trigger comprises an indication of excess resource provisioning within a predetermined time period.

15. A method comprising:
obtaining data related to a plurality of features;
determining a total number of resources to provision among the plurality of features;
inputting, into a trained AI model, the obtained data and the total number of resources to cause the trained AI model to output a plurality of provisions of the total number of resources among the plurality of features; and
outputting the plurality of provisions to a resource provisioning platform.

16. The method of claim 15, further comprising:
receiving a log indicating resources provisioned among the plurality of features;
inputting the log into the trained AI model to cause the trained AI model to output a plurality of updated provisions of the total number of resources among the plurality of features; and
outputting the plurality of updated provisions to the resource provisioning platform.

17. The method of claim 16, further comprising:
determining a pace at which the total number of resources are to be provisioned among the plurality of features; and
determining, based on the log, that an actual pace at which the total number of resources are being provisioned does not match the pace at which the total number of resources are to be provisioned,
wherein inputting the log into the trained AI model is performed responsive to determining that the actual pace at which the total number of resources are being provisioned does not match the pace at which the total number of resources are to be provisioned.

18. The method of claim 16, further comprising:
determining a performance metric for the plurality of provisions, wherein the performance metric indicates a current performance value of the plurality of provisions or a historic future performance of the plurality of provisions; and
determining that the performance metric does not satisfy a performance threshold,
wherein inputting the log into the trained AI model is performed responsive to determining that the performance metric does not satisfy the performance threshold.

19. The method of claim 15, further comprising:
determining one or more parameters based on one or more regulations for sets of data; and
filtering the obtained data according to the one or more parameters.

20. The method of claim 15, further comprising, responsive to detecting an excess provisioning trigger, causing the plurality of provisions to terminate, wherein the excess provisioning trigger comprises an indication of excess resource provisioning within a predetermined time period.
